(19) United States
(12) Patent Application Publication
(10) Pub. No.: US 2018/0292097 A1
(43) Pub. Date: Oct. 11, 2018

(54) PASSIVE ENERGY STORAGE SYSTEMS AND RELATED METHODS

(71) Applicant: Micro-Utilities, Inc., White Plains, NY (US)

(72) Inventor: Herschel SPECTER, White Plains, NY (US)

(73) Assignee: Micro-Utilities, Inc., White Plains, NY (US)

(21) Appl. No.: 16/005,265

(22) Filed: Jun. 11, 2018

Related U.S. Application Data
(63) Continuation of application No. PCT/US2016/066168, filed on Dec. 12, 2016.
(60) Provisional application No. 62/266,608, filed on Dec. 12, 2015.

(51) Int. Cl. F24F 5/00; F25B 15/10; F24F 11/30; F24F 11/67; F24S 20/20

(52) U.S. Cl. CPC F24F 5/0017; F25B 15/10; F24F 11/30; F24F 2005/0025; F24S 20/20; F25B 2339/047; F24F 11/67

(57) ABSTRACT

The present application provides passive energy storage systems and related methods. The systems include hot and cold sections. The hot section includes a thermally insulated hot compartment including thermal energy storage material. The hot section is configured to heat the thermal energy storage material via at least a first electrical power source and to selectively heat a first material. The cold section includes a thermally insulated cold compartment with at least one ice storage container. The cold section is configured to form ice within the at least one ice storage container via a cooling cycle and to selectively treat a second material. The systems and methods are configured to selectively heat cooling material of the cooling cycle to drive the cycle, at least in part, and form the ice via the first electrical power source exterior to the hot compartment and/or by the heat of the hot section.

### CROSS-REFERENCE TO RELATED APPLICATIONS

This present application is a continuation of PCT Patent Application No. US/2016/066168, filed Dec. 12, 2016, and entitled Passive Energy Storage Systems and Related Methods, which claims the benefit of U.S. Provisional Patent Application No. 62/266,206, filed on Dec. 12, 2016, entitled Passive Energy Storage Systems and Related Methods, the contents of which are hereby expressly incorporated herein by reference in their entireties.

### BACKGROUND

This disclosure is generally directed to energy storage systems and related methods. More particularly, the present disclosure is directed to energy storage systems and related methods that utilize two differing passive energy storage systems that interact with each other.

Energy storage can take many forms. One well known form can be characterized as an electricity in and electricity out form. Batteries, compressed air, and pumped storage are examples of this energy storage form. In this energy storage form, electricity is first supplied to cause some reversible medium to change its original status, such as using electricity to pump water up to an elevated storage location, or compressing air to be stored in a cavern, or storing electrons in a battery, etc. This “electricity in” phase may be conducted during periods of low demand for electricity. These “electricity in” processes may then be reversed to an “electricity out” phase by allowing the medium to return towards its original status and to extract electrical energy thereof during periods of high demand for electricity.

Energy storage is a rapidly growing and important technology sector from both an economic and an environmental or sustainability viewpoint. By one estimate, the economic impact of energy storage may be at least $90 billion dollars per year by 2025 and possibly much more (e.g., up to $635 billion) depending on how fast it is applied to vehicles. From an environmental consideration, low cost energy storage is one of many technologies needed to prevent serious damage from climate change. Low cost energy storage could be an important economic benefit to centralized utilities and their customers. Further, without low cost energy storage, the contribution of electricity from distributed energy resources (DER) may remain rather limited.

The need for energy storage is well recognized with renewable energy systems, such as wind power, photovoltaics, solar thermal systems, etc., as these systems may provide variable and/or intermittent power. As such, some renewable energy systems may not easily match the demand for electricity, which may vary seasonally and/or daily in a sine wave-like form from peak demand or load to off-peak demand or load. Some experts thereby consider energy storage solutions as essential for further development of these renewable energy sources.

At this time the contribution of electricity from DER to the U.S. national electricity production may be very small. For example, the amount of electricity generated from solar/PV (photovoltaic) sources in 2014 has been estimated as 18,321 million kilowatt-hours out of 4,092,935 million kilowatt-hours of electricity generated nationally. Not only would the use of low cost energy storage have to increase in order to significantly increase the contribution of DER, but specific forms of energy storage may be needed. For example, energy storage systems with a large footprint and/or capacity, like pumped storage, compressed air, etc., may be best located at or near the point of power generation, such as at a wind farm or at a nuclear power plant, or within the electric grid. As such, these large centralized storage systems may not meet the energy storage requirements of DER systems. By their very nature, DER systems are typically placed locally at individual or small clusters of end users (e.g., dwellings or buildings). In contrast, DER systems typically require the use of co-located energy storage systems, like lead acid batteries, to overcome their variability. However, such batteries are expensive and have lifetimes limited by the number of charge/discharge cycles they experience.

Energy storage systems can also be utilized to lower consumer costs for electricity. For example, research has shown that low cost energy storage can be effective in financially benefiting electricity consumers and utility companies compared to situations without such energy storage systems.

As discussed above, it is generally recognized that energy storage is essential for further development of renewable energy. However, potentially less appreciated, is the need for energy storage for centralized electric power plants. Historically, the need for energy storage at centralized electric power plants was considered minimal, as energy storage was inherently accomplished by the fuel itself, i.e., the energy was stored in the coal, oil, natural gas, uranium, etc. However, environmental considerations, such as climate change, has changed traditional energy production. For example, if the U.S. is to meet the goals of the International Panel on Climate Change (IPCC), virtually all fossil fueled electric power plants may have to be phased out by 2050. However, by 2050, the licenses of all operating nuclear power plants may expire. In 2014, it has been estimates that fossil fueled power plants and nuclear power plants together represented over 86% of the electricity production in the U.S. As such, if one wanted to just match this 86% of the 2014 electricity production capability by 2050, it is estimated that over 13 1,000 megawatt power plants operating at a capacity factor of 90% would have to be put on line every year for the next 35 years. This could cost trillions of dollars and would likely be beyond U.S. national manufacturing capacity. Greater electrified transportation could increase these costs and demands for electricity enormously.

As a result, it may be desirable to extract more electricity per plant as compared to current efficiencies, and thereby reduce the need for new power plants. Meeting today's U.S. peak demands for electricity has resulted in an electric power system that, on average, may only use about half of its production capacity. Energy storage which shifts the production of electricity towards low demand periods and then utilizes this stored energy as demand rises may play an important role if a smaller, but more productive, electricity future is to be obtained.

The demand for electricity is also increasing. For example, electric utilities, such as those located in the northeastern portion of the U.S., typically experience increased peak demand due to the wider use of air conditioning. Because of climate change, the need/use of air conditioning has been predicted to increase over time. Meeting such peak demands through building more power plants or constructing many more miles of transmission lines through populous areas is both expensive and controversial. Reducing air conditioning demands through changes in human behavior has been considered impractical. Energy storage systems are one practical approach to meet such an increased demand for electricity.

Yet another issue may face producers of carbon-free electricity, such as producers of renewable and nuclear electricity. Many, if not most, current consumers of grid electricity utilize fossil fueled end use devices. For example, a utility that supplies a source of carbon-free electricity into a user's home may discover that the user's space heating system, as one example, operates on a fossil fuel (e.g., natural gas or heating oil). This source of carbon-free electricity would be of little use for space heating in such a scenario as it would not be compatible with the user's existing fossil fueled end use device. A carbon-free continuum, from the sources of carbon-free electricity to carbon-free end use devices that are compatible with these sources would be needed to maximize the use of carbon-free electricity (e.g., to achieve the IPCC goals).

Bringing the sources of carbon-free electricity into harmony with carbon-free end use devices may be critical, but it is a very large undertaking. Today, it is estimated that about 10% of greenhouse gas releases in the U.S. come from the residential and commercial sectors. In order to meet the goals of the IPCC and to create an overall electric power system that exhibits a carbon-free continuum, it is expected that most of these end use devices that burn fossil fuels would have to be replaced with “clean” technologies. However, there may be about 132 million housing units in the U.S. and tens of thousands of commercial businesses utilizing fossil-fuel based technologies, which could equate to replacing about 240 million fossil-fuel-based end use devices by 2050 to meet the goals of the IPCC. Just as bringing over 13 1,000 megawatt-electrical power plants on line each year until 2050 is likely unattainable, replacing such 240 million or more fossil-fuel-based end use devices by 2050 would be extremely difficult and improbable due to manufacturing and cost limitations, unless, perhaps, many of these end use devices can be replaced by a single multi-functional efficient appliance, for example.

Accordingly, alternative energy storage systems and related methods that can increase the usage of renewable energy, reduce current peak electricity demand and/or lower electricity costs is desirable.

### SUMMARY

In one aspect, this disclosure provides a passive energy storage system including a hot section and a cold section. The hot section includes a thermally insulated hot compartment with thermal energy storage material. The hot section is configured to heat the thermal energy storage material via at least a first electrical power source and to selectively pass a first material through the hot compartment to heat the first material, The cold section includes a thermally insulated cold compartment with at least one ice storage container. The cold section is configured to form ice within the at least one ice storage container via an ammonia-water absorption cycle and to selectively cool and dehumidify a second material via the cold compartment. The system is configured to selectively heat ammonia of the ammonia-water absorption cycle to drive the cycle and form the ice via the first electrical power source and the hot compartment. The hot compartment and the at least one cold compartment are differing compartments that are thermally insulated from each other.

In some embodiments, the hot compartment may be configured to heat the thermal energy storage material via at least the first electrical power source via conduction. In some embodiments, the first electrical power source may be alternating current from a grid-based off-peak electrical supply. In some such embodiments, the hot compartment may be configured to heat the thermal energy storage material via at least a second electrical power source, and the second electrical power source may be direct current from a distributed energy resources (DER) system.

In some embodiments, the thermal energy storage material may include a mass of ceramic and/or metal material. In some embodiments, the first material may be air, and the hot section may be configured to pass the air through the hot compartment to heat the air for use in space heating and/or heated water production. In some embodiments, the first material may be a fluid, and the hot section may be configured to draw the fluid through the hot compartment to heat the fluid for use in space heating and/or heated water production. In some embodiments, the second material may be air, and the cold section may be configured to pass the air through the cold compartment to cool and dehumidify the air for use in air conditioning and/or refrigeration. In some embodiments, the second material may be air, and the cold section may be configured to pass the air through the cold compartment to cool and dehumidify the air for use in a compressor of a gas turbine-based generator system that produces electrical power.

In some embodiments, the cold compartment may include a plurality of ice storage containers. In some embodiments, the system may further include piping that carries the ammonia and an electrical heating coil coupled to the piping, and the first electrical power source may power the electrical heating coil to heat the ammonia carried within the piping.

In some embodiments, the system may be configured to heat ammonia of the ammonia-water absorption cycle to drive the cycle via heat from the hot compartment. In some such embodiments, the system may be configured to heat ammonia of the ammonia-water absorption cycle to drive the cycle via heat form the hot compartment by passing the ammonia through a heat exchanger of the ammonia-water absorption cycle that is heated by the first material. In some such embodiments, the at least one ice storage container may include an evaporator of the ammonia-water absorption cycle that receives cooled liquid ammonia of the ammonia-water absorption cycle. In some such embodiments, the evaporator may include tubing containing the cooled liquid ammonia and at least one evaporator plate coupled to the tubing. In such some embodiments, the at least one ice storage container may further include a fluid for the formation of the ice therefrom and an airspace. In some such other embodiments, the at least one ice storage container may be airtight.

In some embodiments, the system may further include a control system that controls the hot and cold sections such that the cold section utilizes the ammonia-water absorption cycle to form the ice as a continuous ice making process while previously-formed ice contained within the at least one cold compartment melts. In some embodiments, the system may further include a control system that controls the hot and cold sections such that the cold section forms ice at substantially the same rate as previously-formed ice therein melts such that no net ice is formed in the at least one ice storage container. In some embodiments, the system may further include a control system that controls the hot and cold sections such that the cold section forms a bulk of ice at a first time period in the at least one ice storage container to cool the second material during a second time period subsequent to the first time period.

In some embodiments, the system may be configured to heat the ammonia of the ammonia-water absorption cycle to drive the cycle and form the ice via the first electrical power source during a first time period and via the hot compartment a second time period that differs from the first time period. In some such embodiments, the system may be configured to heat the ammonia of the ammonia-water absorption cycle via the hot compartment at the second time period by passing the ammonia through a heat exchanger that is heated by the first material. In some embodiments, the system may further include a housing, and at least the hot compartment and the at least one cold compartment may be contained within the housing.

In another aspect, this disclosure provides a system for treating air for an electrical power generation system including a cold section and a hot section. The cold section includes a thermally insulated cold compartment with at least one ice storage container. The cold section is configured to selectively form ice within the at least one ice storage container via an ammonia-water absorption cycle and to cool and dehumidify air via the cold compartment for feeding to a compressor of a turbine-based generator system for the generation of electrical power. The hot section includes a thermally insulated hot compartment including thermal energy storage material. The hot section is configured to heat the thermal energy storage material via at least a first electrical power source and to selectively heat ammonia of the ammonia-water absorption cycle to drive the cycle and form the ice via the first electrical power source and the hot compartment. The hot compartment and the at least one cold compartment are differing compartments that are thermally insulated from each other.

In some embodiments, the hot section may be configured to pass a first material through the hot compartment to heat the first material. In some such embodiments, the system may be configured to heat the ammonia by passing the ammonia through a heat exchanger that is heated by the first material. In some such embodiments, the at least one ice storage container may include an evaporator therein, and the ammonia may be directed through the evaporator. In some embodiments, the evaporator may include tubing containing the ammonia and at least one evaporator plate coupled to the tubing. In some such embodiments, the at least one ice storage container may further include an airspace and a fluid surrounding the evaporator for the formation of the ice therefrom. In some such embodiments, the at least one ice storage container may be airtight. In some embodiments, the turbine-based generator system may include a gas turbine that powers an electric generator, and the compressor may compresses the cooled and dehumidified input air and feeds it to the gas turbine.

In another aspect, this disclosure provides an energy storage and generation system including a hot section, a turbine, and a cold section. The hot section includes a thermally insulated hot compartment with thermal energy storage material. The hot section is configured to heat the thermal energy storage material via at least a first electrical power source and to pass input water and air through the hot compartment to produce steam and heated air therefrom. The turbine is configured to drive a generator to produce electricity, and to receive the steam produced by the hot section and to exhaust the steam after use thereby. The cold section includes a thermally insulated cold compartment with at least one ice storage container. The cold section is configured to form ice within the at least one ice storage container via an ammonia-water absorption cycle and to condense the steam exhausted by the turbine to form the input water. The system is configured to heat ammonia of the ammonia-water absorption cycle to drive the cycle and form the ice via at least the heated air produced by the hot section and the first electrical power source. The hot compartment and the at least one cold compartment are differing compartments that are thermally insulated from each other.

In some embodiments, the input water, the steam produced by the hot section and the steam exhausted by the turbine may form a closed loop configuration. In some such embodiments, the system may further include a pressurizer including an air space in fluid connection with at least one of the input water, the steam produced by the hot section and the steam exhausted by the turbine to control the pressure of the closed loop within a predefined limit or range. In some embodiments, the input water from the cold section may be pumped from the cold section into the hot section. In some embodiments, the system may further include a steam separator positioned between the hot section and the turbine configured to separate water droplets from the steam received by the turbine.

In some embodiments, the system may further include a heat exchanger that is heated by the heated air produced by the hot section, and the ammonia of the ammonia-water absorption cycle may be heated by passing the ammonia through the heat exchanger. In some such embodiments, the at least one ice storage container may include an evaporator, an airspace and a fluid surrounding the evaporator for the formation of the ice therefrom, and the ammonia may be directed through the evaporator. In some such embodiments, the evaporator may include tubing containing the ammonia and at least one evaporator plate coupled to the tubing. In some such embodiments, the at least one ice storage container may be airtight. In some embodiments, the first electrical power source may heat the ammonia of the ammonia-water absorption cycle by heating piping that carries the ammonia with an electric coil that is powered by the first electrical power source, and the first electrical power source may be off-peak grid electricity.

In another aspect, this disclosure provides a passive energy storage system that includes a hot section and an electrical power generation system. The hot section includes a thermally insulated hot compartment including thermal energy storage material. The hot section is configured to heat the thermal energy storage material via at least a first electrical power source and to selectively pass air through the hot compartment to heat the air. The electrical power generation system includes a gas turbine receiving a flow of the heated air and a generator powered by the turbine configured to produce output electrical power.

In some embodiments, the system may further include a heat exchanger configured to heat a flow of material passing therethrough, and the turbine may exhaust the heated air to the heat exchanger to heat the flow of air passing therethrough. In some such embodiments, the heated flow of material may be utilized for space heating and/or hot water production.

In some embodiments, the thermal energy storage material may be a mass of ceramic and/or metal material. In some embodiments, the first electrical power source may be direct electrical current provided by a distributed energy resource (DER). In some such embodiments, the DER may be a photovoltaic system. In some other such embodiments, the output electrical power may be alternating electrical current. In some other such embodiments, the hot compartment may be configured to heat the thermal energy storage material via at least the first electrical power source via conduction.

In another aspect, this disclosure provides a thermal energy storage system including an ammonia-based cooling system and a coolant-based cooling system. The ammonia-based cooling system includes an ammonia-water absorption cycle including an evaporator portion coupled to an evaporator plate. The coolant-based cooling system includes a closed loop of coolant selectively flowing through a chiller, a cold compartment, an ice storage tank including a first material, and a heat exchanger configured to selectively cool a flow of second material flowing therethrough. The evaporator portion and evaporator plate of the ammonia-based cooling system are positioned within the cold compartment to selectively cool the flow of coolant. The coolant-based cooling system includes an ice storage mode, wherein the chiller cools the flow of coolant to a temperature below a freezing temperature of the first material and the cooled flow of coolant passes through the ice storage tank to freeze a first batch of the first material, and an ice melt mode, wherein the chiller is deactivated and the flow of coolant is cooled by the first batch of ice within the ice storage tank and the coolant-based cooling system via the cold compartment.

In some embodiments, the coolant-based cooling system may operate in the ice storage mode during off-peak electrical time periods. In some such embodiments, at least a portion of the coolant-based cooling system may be powered by grid-based electrical power. In some embodiments, the coolant-based cooling system may operate in the ice melt mode during peak electrical time periods. In some such embodiments, at least a portion of the coolant-based cooling system may be powered by grid-based electrical power. In some other such embodiments, at least a portion of the ammonia-based cooling system may be powered by electrical power provided by a distributed energy resource (DER). In some such embodiments, the DER may be a photovoltaic system.

In some embodiments, the coolant-based cooling system may further cool the flow of coolant during the ice storage mode via the cold compartment. In some embodiments, the flow of coolant may flow through the ice storage tank and the cold compartment during the ice melt mode. In some such embodiments, the flow of coolant may flow through the ice storage tank at a temperature below the melting point of the first material such that at least a portion of the first batch of melts.

In some embodiments, the first material may be water. In some embodiments, the coolant may include glycol. In some embodiments, the coolant-based cooling system may be powered by grid based electrical power. In some embodiments, the cooled flow of second material may be utilized for air conditioning and/or refrigeration.

These and other objects, features and advantages of this disclosure will become apparent from the following detailed description of the various aspects of the disclosure taken in conjunction with the accompanying drawings.

### BRIEF DESCRIPTION OF THE DRAWINGS

FIG. 1 illustrates an exemplary embodiment of an energy storage system and method of the present disclosure;

FIG. 2 illustrates an exemplary electrical input of the energy storage system of FIG. 1;

FIG. 3 illustrates an exemplary hot water configuration of the energy storage system of FIG. 1;

FIG. 4 depicts an exemplary heating chamber of the hot water configuration of FIG. 3;

FIG. 5 illustrates an exemplary cold compartment with a plurality of exemplary ice storage compartments of the energy storage system of FIG. 1;

FIG. 6 illustrates the exemplary cold compartment of FIG. 5 with the exemplary ice storage compartments removed;

FIG. 7 illustrates an exemplary coupling mechanism of the exemplary cold compartment and the plurality of exemplary ice storage compartments of the energy storage system of FIG. 1;

FIG. 8 illustrates a cross-section of an exemplary ice storage compartment of the energy storage system of FIG. 1;

FIG. 9 illustrates an enlarged portion of the exemplary ice storage compartment of FIG. 8;

FIG. 10 illustrates a side view of an exemplary evaporator plate and evaporator piping system of the exemplary ice storage compartments of the energy storage system of FIG. 1;

FIG. 11 illustrates a perspective view of the exemplary evaporator plate and evaporator piping system of FIG. 10;

FIG. 12 illustrates an exemplary ammonia-water absorption cycle of the energy storage system of FIG. 1;

FIG. 13 depicts the flow of ammonia through a portion of the ammonia-water absorption cycle of FIG. 12;

FIG. 14 depicts the flow path of ammonia through the ammonia-water absorption cycle of FIG. 12;

FIG. 15 illustrates an exemplary heat exchanger of the energy storage system of FIG. 1 that heats the ammonia of the ammonia-water absorption cycle of FIG. 12;

FIG. 16 illustrates another exemplary embodiment of an energy storage system and method of the present disclosure;

FIG. 17 illustrates another exemplary embodiment of an energy storage system and method of the present disclosure;

FIG. 18 illustrates another exemplary embodiment of an energy storage system and method of the present disclosure;

FIG. 19 illustrates another exemplary embodiment of an energy storage system and method of the present disclosure; and

FIG. 20 illustrates an exemplary cooling compartment including of the energy storage system of FIG. 19 including an evaporator plate and a flow of coolant.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of parameters are not exclusive of other parameters of the disclosed embodiments. Components, aspects, features, configurations, arrangements, uses and the like described, illustrated or otherwise disclosed herein with respect to any particular embodiment may similarly be applied to any other embodiment disclosed herein.

This disclosure provides for low cost energy storage systems and related methods. The energy storage systems and methods may include operating running about one tenth of the cost of many current storage systems, such as battery-based energy storage systems. The energy storage systems and methods may be capable of operating at near 100% efficiency and function for an unlimited number of operating cycles. The energy storage systems and methods may avoid using exotic imported materials and, instead, rely on a simple supply chain based on domestic sources. By putting idle capacity to work, in some embodiments of the energy storage systems and methods almost twice as much electricity can be produced from existing power plants as compared to prior energy storage systems and methods.

The energy storage systems and methods may provide for an increase in deliverable electricity without major expansions of the electrical power transmission and distribution grids. The energy storage systems and methods may use off-peak electricity from the grid, supplemented by distributed energy resources (DER), where available. Use of DER and with the energy storage systems and methods of the present disclosure may reduce the costs of DER in about half, for example. As another example, relatively widespread implementation of the energy storage systems and methods may lower electricity costs for consumers without forcing them to change their energy usage patterns. The energy storage systems and methods may provide electricity when the consumer wants it (i.e., on demand) and without a cost penalty for usage during high demand periods.

The energy storage systems, in one embodiment, may selectively provide air conditioning, space heat, and/or hot water. The systems may also be capable of shifting electricity production, for air conditioning purposes for example, from peak demand periods to off-peak times. Further, space heating and hot water may be provided by the systems carbon-free at the point of use (by providing such without fossil fuels, for example). In this way, for example, the energy storage systems and methods of the present disclosure can shift grid electricity use to off-peak electricity and replace fossil fueled space heating and hot water mechanics, thereby creating a new income stream for utilities while providing carbon credits.

The energy storage systems may be thermal energy storage systems, and thereby effective in reducing the cost of DER systems. The systems of the present disclosure may be designed substantially different than many current DER systems that are designed to replace electrons from the grid and/or add electrons to the grid. The energy storage systems of the present disclosure may, instead, be designed to separate DER electrons from a traditional electric grid. In this way, the systems prevent the flow of electrons from one electricity source into or to another, unlike many current DER systems. This separation eliminates issues of potential grid instabilities, no net meters are needed, and removes the potential of legal disputes over the economic value of DER-created electrons that flow into the grid. Further, the systems take away the need for fossil fueled power plants to be kept “at the ready” should a particular DER output suddenly vary. Still further, with use of the systems of the present disclosure, there is no need to match DER electrical output with the variable electricity demand on the grid.

The energy storage systems of the present disclosure utilize DER electrons to make heat, instead of prior energy systems that attempt to put them into the grid. Utilizing DER electrons to make heat provides economic benefits for photovoltaic and/or wind power systems. For example, this “heat approach” virtually eliminates the “balance of system” costs when DER sources are connected. Further, the energy storage systems eliminate need for batteries to back up DER systems because of intermittency or variability. Rather than including batteries or another traditional energy storage mechanism, the current energy storage systems utilize a bulk of pre-installed thermal energy storage material as the energy storage medium. DER systems are able to simply and easily couple to the energy storage systems of the present disclosure in a “plug and play” mode—like a typical electrical plug and receptacle. As one of ordinary skill in the art would appreciate, there is therefore no need to try to match DER and grid voltages, phases, or any other electricity characteristics. “Balance of system” power conditioning components, and “soft costs” like permitting, installation, interconnection and maintenance, may be reduced or simply not be needed. Some studies have estimated “balanced of system” hardware and “soft” costs at about 68% of the total costs of photovoltaic systems in residential installations.

Regarding environmental effects, the energy storage systems of the present disclosure could reduce the amount or need for inefficient fossil fueled “peaker” plants because, for example, air conditioning can be shifted to cleaner off-peak sources of electricity, the burning of fossil fuels in space heating and making hot water at the point of use could be eliminated, lower energy costs could accelerate the use of carbon free DER systems, and/or co-location of the storage systems could encourage a more rapid deployment of electrified transportation. As another example, the energy storage systems could make base load carbon free nuclear power plants more economical since energy storage could turn them into load following plants. Still further, as the energy storage systems could reduce the burning of fossil fuel, air quality could be improved as greenhouse gases releases are decreased.

The energy storage systems of the present disclosure may also provide a double layer of energy security to cope with emergencies when combined with distributed energy sources (DER systems), such as during cyber-attacks on the grid, extreme weather conditions, etc. Still further, as the energy storage systems are capable of storing off-peak electricity for subsequent use in air conditioning, for example, the energy storage systems provide for, or increase, a reserve margin of utilities, thereby reducing the likelihood of blackouts during peak demand days.

The energy storage systems and methods of the present disclosure may differ based on a particular desired output and/or use/installation, for example, but may include or operate on common principles/components. For example, the energy storage systems may each include two differing but interacting, passive energy storage systems. The passive energy storage systems may include a hot section and a cold section. The terms “hot” and “cold” are used herein as comparative or relative temperatures and do not indicate any specific or particular temperatures. Both the hot section and the cold section may be largely passive systems in that the storage media do not have motors, pumps, compressors or other equipment with moving parts. Using passive designs lowers costs, minimizes maintenance, and helps to assure a long operating life. The hot section may include a thermally insulated hot compartment including thermal energy storage material, and be configured to heat the thermal energy storage material via at least a first electrical power source and to selectively heat a first material, such as by passing the first material through the hot compartment. The cold section may include a thermally insulated cold compartment with at least one ice storage container, and be configured to form ice within the at least one ice storage container via an ammonia-water absorption cycle (or ammonia absorption refrigeration/air conditioning cycle) and to selectively cool and dehumidify (and/or condense) a second material, such as by passing the second material through the cold compartment. The hot compartment and the at least one cold compartment may be differing compartments that are thermally insulated from each other. The hot and cold passive energy storage systems may interact in that the system may be configured to selectively heat ammonia of the ammonia-water absorption cycle of the cold section, via heat from the hot section, to drive the cycle and form the ice within the at least one ice storage container. Independent of the heat from the hot section, ice may be formed within the at least one ice storage container by heating ammonia via an electrical power source. The energy storage systems may also include a control system that is configured to control and/or monitor the hot section and the cold section, such as to control flow rates of the first and second materials, monitor the temperature of the hot compartment, monitor the amount (e.g., formation rate and/or melting rate) of ice within the at least one ice storage container. The energy storage systems may be readably scalable and adaptable.

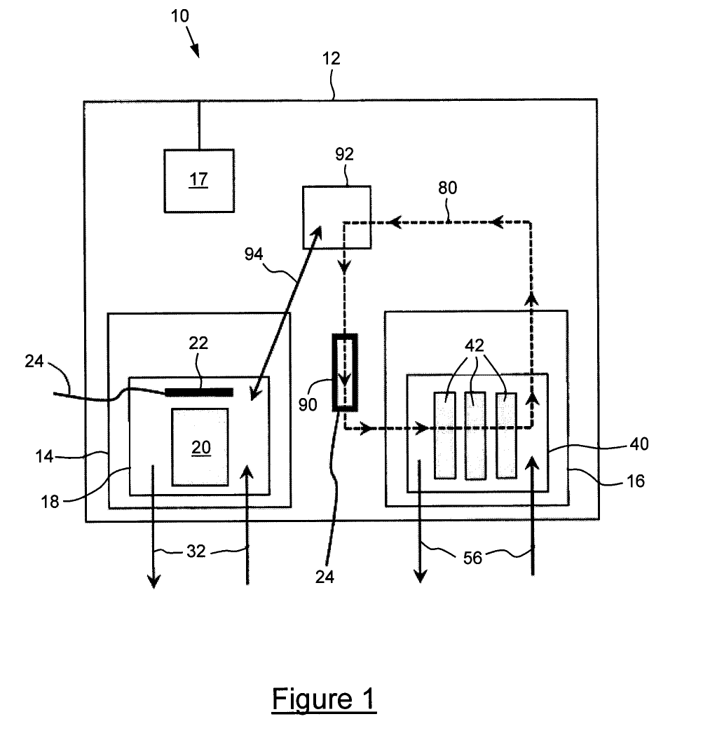

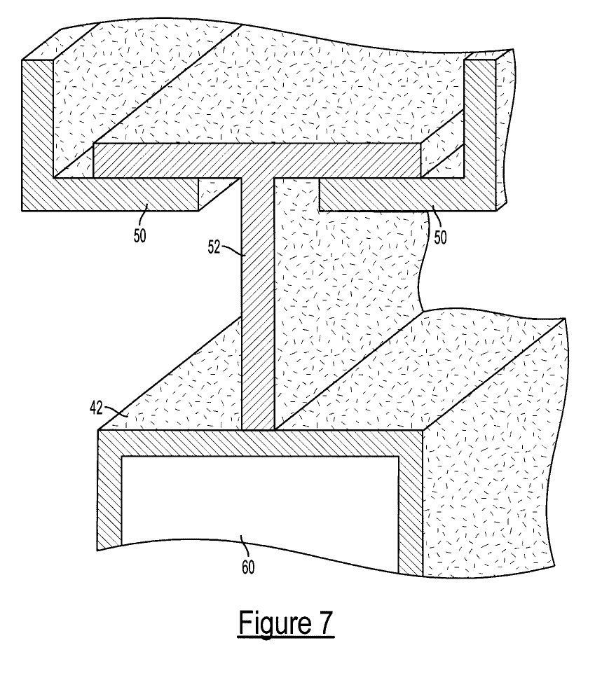

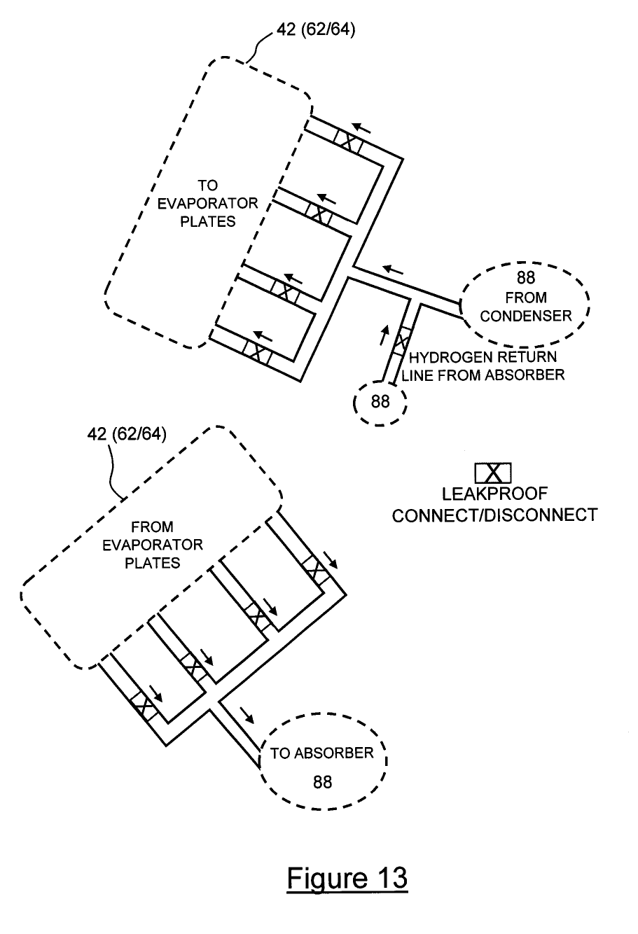

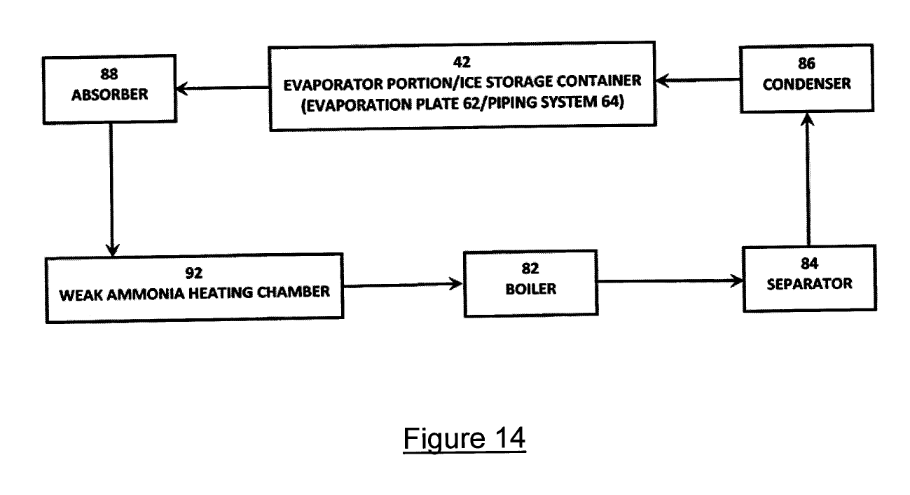

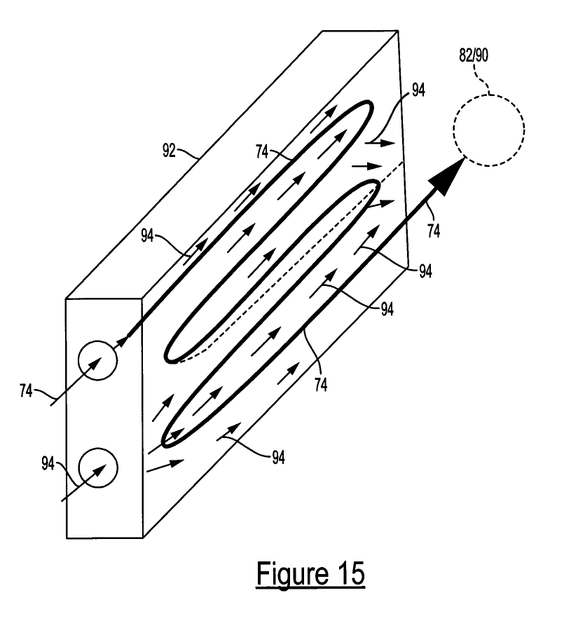

FIGS. 1-15 illustrate one exemplary embodiment of an energy storage system and method of the present disclosure, indicated generally as reference numeral 10 (e.g., see FIG. 1), which is configured to utilize input electricity and output at least one of air conditioning (AC), hot water and/or space heat. The energy storage system 10 may provide fossil fuel free space heating and hot water at the point of use, and shift AC electrical loads to off-peak time periods. As the energy storage system 10 may not burn fossil fuels, it may thereby be able to reduce the threat of climate change while providing health benefits through cleaner air. As explained further below, the energy storage system 10 may utilize DER and/or grid power. The energy storage system 10 may thereby be referred to as an electricity in and heat and/or cold out (EI-HCO) configuration.

As shown in FIG. 1, the energy storage system 10 may include a housing 12 that at least partially houses a hot section 14, a cold section 16 and/or a control system 17. However, at least a portion of at least one of the hot section 14, the cold section 16 and/or the control system 17 may be positioned exterior to the housing 12. The energy storage system 10 may be located proximate to one or more residence, business, or any other dwelling for the supply of AC, hot water and/or space heat thereto.

As shown in FIG. 1, the hot section 14 of the energy storage system 10 may include a thermally insulated hot compartment 18 including thermal energy storage material 20. The hot compartment 18 may be thermally insulated so as to maintain heat therein as compared to exterior of the hot compartment 18, the hot section 14 and/or the housing 12. The hot compartment 18 may be thermally insulated by any known means, such as by forming the compartment, and/or covering the compartment, with material(s) including an effective R-value. The hot compartment may also be cooled by passing cool air around its outside surfaces.

As also shown in FIG. 1, the hot compartment 18 may include a heating mechanism 22 that is powered by a first electrical power source 24 and configured to heat the thermal energy storage material 20. The heating mechanism 22 may be any heating mechanism capable of heating and maintaining the temperature of the storage material 20 via the first electrical power source 24 to/at relatively high temperatures. For example, if input air (e.g., first material 32, as explained below) is blown through this hot compartment 18, the storage material 20 may be of a temperature such that the input air may obtain temperatures up to 1300 degrees F. In some embodiments, the heating mechanism 22 may heat the thermal energy storage material 20 via at least the first electrical power 24 source via conduction. For example, the heating mechanism 22 may include resistance wires that are in contact with the storage material 20 that raise the temperature of the storage material 20 (and, potentially, the wires) when the resistance wires are energized by the first electrical power source 24. In some other embodiments, the heating mechanism 22 may heat the thermal energy storage material 20 via at least the first electrical power 24 source via a mode other than, or in addition to, conduction.

The thermal energy storage material 20 within the thermally insulated hot compartment 18 may be any material that is capable of heating to relatively high temperatures over an extended period of time without degrading. In some embodiments, the thermal energy storage material 20 may be a mass of ceramic and/or metal material or media. In one example, the thermal energy storage material 20 may be a plurality of ceramic bricks.

It is noted that the thermal energy storage material 20, as a heat storage media, includes a relatively long operational life as compared to many lead acid batteries, for example, which have a limited number of charge and discharge cycles and/or storage that first requires equipment with moving parts, like compressors. The thermal energy storage material 20 is also relatively compact because of the high surface temperatures of the material, which can minimize the heat transfer area needed to accomplish heating of a material passing over or about the material.

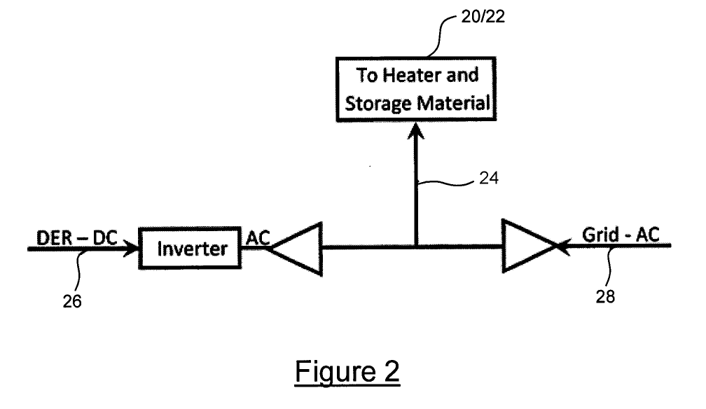

As shown in FIG. 2, the first electrical power 24 that powers the heating mechanism 22 that, in turn, heats the thermal energy storage material 20 may be DER power 26, grid power 28 or a combination thereof. As illustrated in FIG. 2, direct electrical DER current 26 may be converted to alternating current via an inverter, and then directed to the heating mechanism 22 to heat the thermal energy storage material 20. Alternatively, traditional power grid alternating electrical current 28 may be directed to the heating mechanism 22 to heat the thermal energy storage material 20. Still further, a combination of DER power 26 and grid power 28 may be directed to the heating mechanism 22 to heat the thermal energy storage material 20.

The electricity that comes from the grid 28 would likely have a price structure set by the local electric utility or public service commission. Typically, the price of electricity from a grid is divided into multiple domains, at least one off-peak time domain with designated hours and at least one on-peak time domain for the remaining hours in a 24 hour cycle. The system 10 may be configured to utilize DER electricity 26 (as the first electrical power source 24) whenever available, and the DER electricity 26 may be stored in the storage material 20 as heat via the heating mechanism 22. The system 10 may also be configured to utilize grid based electricity 28 (as the first electrical power source 24) only during off-peak time periods for example. If DER power 26 is not available or there is little or no output from the DER system(s), for example, off-peak electricity from the grid 28 may be used to maintain storage material 20 temperatures, if necessary. For example, in a system 10 configuration that includes a photovoltaic DER power source 26, the electrical output thereof is at its highest during the day, especially during the summer (when air conditioning demands also are at their highest). When daylight is available, the photovoltaic DER power source 26 may be utilized to maintain the temperature of the storage material 20, if necessary. When daylight is not available (e.g., at night) or not sufficient to maintain the temperature of the storage material 20, off-peak grid-based electricity 28 may be utilized. This synergy between power from DER power 26 and grid-based centralized electric power plant power 28 is made possible due to the use of the thermal energy storage material 20 in the system 10. Still further, if both DER power 26 and grid off-peak power 28 are not available as the first electrical power sources 24, the system 10 may utilize on-peak grid-based electricity, however only if necessary for example. The control system 17 may limit the amount of electricity 24 is put into the system 10 to prevent overheating of the thermal energy storage material 20 or any other temperature sensitive material within system 10. As an alternative to using the control system 17 to prevent overheating when both DER power 26 and grid-based electricity 28 are available, the maximum electricity derived from DER sources may be intentionally limited, for example. Maximum DER electricity 26 input may vary with location, for example, but may be known from previous renewable energy measurements (such as from recorded peak solar insolation at or near the site location). The design or configuration of a DER system may be such that the peak DER electricity input 26 to the system 10 would not cause overheating, assuming no additional electricity input from grid-based electricity 28, for example.

The hot section 14 may be configured to selectively pass at least one first material 32 through the hot compartment to heat the first material 32. For example, the first material 32 may pass through the hot compartment 18 and over or about the heated storage material 20 such that the first material 32 is hotter upon exiting the hot compartment 18 as compared to entering the hot compartment 18. The heated first material 32 may be utilized to provide space heat to an area, hot water and/or heat ammonia of the ammonia-water absorption cycle (or ammonia absorption refrigeration/air conditioning cycle) of the cold section 16 to drive the cycle, as discussed further below. For example, the heated first material 32 may be mixed with cooler first material, and this mix may be utilized to provide space heat to an area, hot water and/or heat ammonia of the ammonia-water absorption cycle of the cold section 16 to drive the cycle.

As explained above, the heat storage material 20 may be heated by off-peak grid electricity 28 and/or DER electricity 26, if available. As such, the system 10 may be configured to include a charging state or time period in which off-peak grid electricity 28 and/or DER electricity 26 is available and acts as the first electrical input 24 to heat the heat storage material 20, and a discharging or non-charging state or time period when off-peak grid electricity 28 and/or DER electricity 26 is not available or otherwise does not heat the heat storage material 20. In this way, the temperature (e.g., surface temperature) of the heat storage material 20 may vary during the course of a particular time period (e.g., during the course of a day) because once off-peak electricity 28 becomes unavailable or otherwise is prevented form heating the heat storage material 20 (and DER power 26 is insufficient or not available), for example, the first material 32 flowing through the hot compartment 18 past the heat storage material 20 would slowly cool the heat storage material 20. In such a scenario, once the off-peak electricity 28 becomes available or otherwise is able to heat the heat storage material 20, the heat storage material 20 will experience a temperature rise.

In some embodiments, the system 10 may monitor the temperature of the heated first material 32 (e.g., via the control system 17), and correspondingly control the heating of the storage material 20, such as correspondingly control an amount of utilized grid-based off-peak electricity 28. For example, if the system 10 determines the temperature of the first material 32 heated by the hot section 14 is too high (e.g., above a predefined temperature threshold or range) during a charging state, such as when off-peak power 28 is utilized to heat the storage material 20, the system 10 (e.g., the control system 17) may reduce or cease the grid-based off-peak electricity 28. As another example, if the system 10 determines the temperature of the first material 32 heated by the hot section 14 is too low (e.g., below a predefined temperature threshold or range, such as 1300 degrees F.), more of the grid-based off-peak electricity 28 may be permitted to be utilized to heat the storage material 20.

Although the temperature of the storage material 20 may have some effect on the temperature of the first material 32 flowing through the hot compartment 18, the system 10 be configured to control or maintain the space heating and/or the hot water provided by the system 10 via the first material 32 independently of the temperature of the storage material 20. As discussed above, the system 10 may be configured to heat the storage material 20 via a first electrical input 24 (such as off-peak grid-based electricity 28 and/or DER electricity 26), to relatively high temperatures, such as temperatures sufficient to heat the first material 32 flowing through the hot compartment 18 to as much as 1300 degrees F. The system 10 may be configured to blend the heated first material 32 with a cooler material, such as room temperature air, to achieve a mixed material temperature suitable for space heating and/or hot water creation. As explained in further detail below, the system 10 may include at least one variable speed blower or fan (which may be controlled by the control system 17) for separately controlling the flow of the heated first material 32 and the relatively cooler material. The system 10 may thereby be configured to adjust the relative flow of the heated first material 32 and the relatively cooler material to control the temperature of the mixed material temperature and, thereby maintain a desirable space heat and/or hot water production temperature (regardless of the exact temperature of the storage material 20). In this way, the system 10 may be configured to selectively and independently control both the heating of the storage material 20 and the temperature of the mixed material temperature and, thereby maintain a desirable space heat and/or hot water production temperature.

For example, in a space heating configuration of the system 10 the first material 32 may be air, and the system 10 may include at least one variable speed fan or blower that is configured to draw or force the air 32 past/over the heated storage material 20 to raise the temperature of the air 32 (potentially as high as 1300 degrees F., for example). The air 32 heated by the heated storage material 20 may be, at least partially, air drawn from the space heated area. The at least one fan may also draw air from the space heated area and mix it with the heated air 32 supplied by the hot section 14 (i.e., bypass the hot section 14 and mix it with air heated by the hot section 14). The air flow rates of the air heated by the hot section 14 and the un-heated air can be adjusted with the at least one variable speed fan to achieve an acceptable exit temperature of the mixed heated air, such as within the 120 to 150 degree F. range. The mixed heated or warmed air may then be distributed into the space heated area. As another example, the first material 32 may be a fluid, and the fluid first material 32 may be drawn through the hot compartment 18 and utilized to heat air for space heating (e.g., via a heat exchanger).

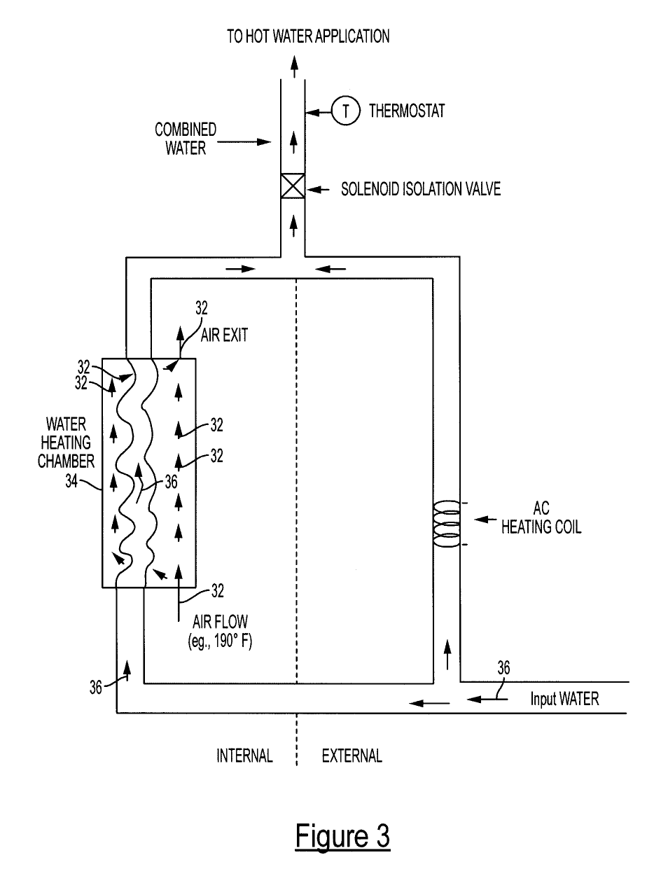

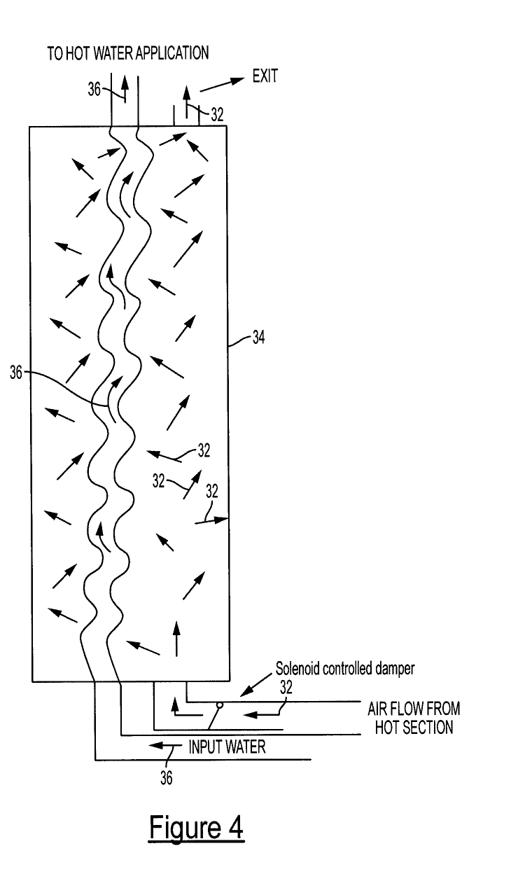

As another example, in a hot water configuration of the system 10 the first material 32 may be air, and the system 10 may heat the air 32 as described above with respect to the space heating configuration of the system 10. Similarly, the heated air 32 may (or may not) be mixed with unheated air as also described above with respect to the space heating configuration of the system 10. The air 32 in the hot water configuration of the system 10 may be the same air 32 that is utilized in the space heating configuration of the system 10, or the air 32 may be a separate and distinct flow through the hot compartment 18. The system 10 may be configured to simultaneously provide both space heat and hot water, if desired (or one and not the other). In one embodiment as shown in FIGS. 3 and 4, the heated air 32 in the hot water configuration of the system 10 may be fed to a water heating chamber 34. The hot water chamber 34 may be configured to pass input water 36 (such as water supplied by a municipality, a well, holding tank, etc.) through a first passageway, and to pass the heated air 32 through a second passageway separated from, but interacting with, the first passageway. In some embodiments, the first passageway may extend through the second passageway such that the input water 36 is directed through the heating chamber 34 through the first passageway, and thereby, through the heated air 32, and the heated air 32 may thereby, act on the first passageway to heat the input water 36, as shown in FIGS. 3 and 4. The heated input water 36 may be mixed with unheated or partially heated input water 36 to regulate the temperature thereof and, ultimately, supply the heated input water 36 to a user. The heated air 32 may be recirculated through the hot compartment 18 and the heating chamber 34. As another example, the first material 32 may be water, and the first water material 32 may be drawn through the hot compartment 18 to produce such hot water.

As shown in FIGS. 1 and 5-12, the cold section 16 of the energy storage system 10 may include a thermally insulated cold compartment 40 including at least one ice storage container 42 therein. The cold compartment 40 may be thermally insulated so as to maintain cool temperatures therein as compared to the exterior of the cold compartment 40, which may include the cold section 16 and/or the housing 12. The cold compartment 40 may be thermally insulated by any known means, such as by forming the compartment, and/or covering the compartment, with material(s) including with an effective R-value.

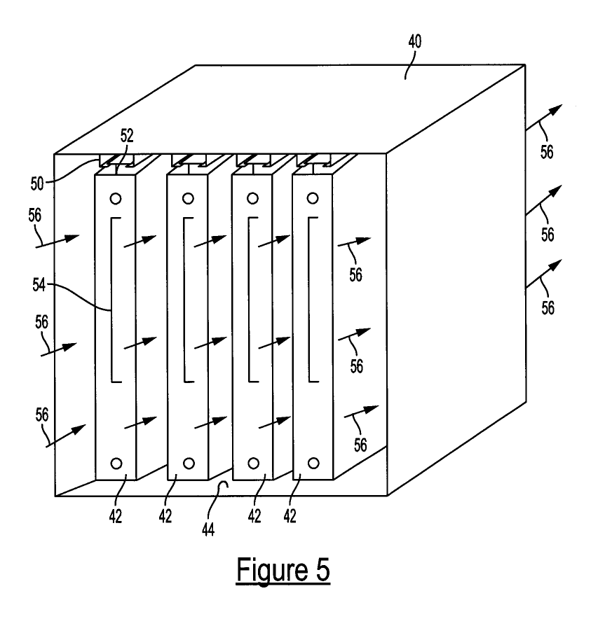

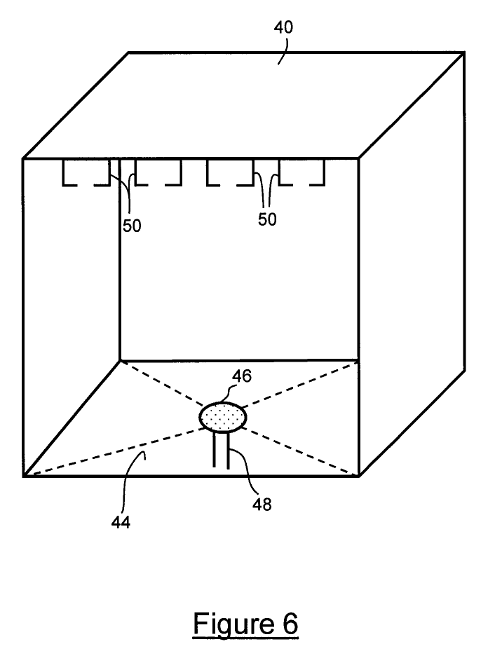

As shown in FIGS. 5 and 6, the cold compartment 40 may form a cavity in which the at least one ice storage container 42 is positioned. A floor portion 44 of the cold compartment 40 may be convex or otherwise pitched or shaped such that a low point is formed, as shown in FIG. 6. As also shown in FIG. 6, the cold compartment 40 may include a drain aperture 46 at or proximate to the low point of the floor portion 44. In this way, the floor portion 44 and drain aperture 46 may direct liquid or other material out of the cold compartment 40, such as condensation formed on the at least one ice storage container 42 as explained further below. A check valve 48 may be in communication with the drain aperture 46, as shown in FIG. 6, to ensure proper drainage and prevent backflow.

The cold compartment 40 may also include at least one container support mechanism 50 associated with each ice storage container 42, as shown in FIGS. 5-7, and each ice storage container 42 may include a coupling mechanism 52, as shown in FIGS. 5-8. The coupling mechanism(s) 52 of the cold compartment 40 and the container support mechanism 50 of the ice storage container(s) 42 may be configured to removably mate such that the ice storage container(s) 42 is removably coupled within the cold compartment 40. The arrangement of the least one container support mechanism 50 may be configured to space a plurality of ice storage containers 42, if provided, within the cold compartment 40 such that a gap or space is provided substantially about each ice storage container 42, as shown in FIG. 5. As also shown in FIG. 5, each ice storage container 42 may also include an engageable member 54 for manually removably coupling the at least one container support mechanism 50 with the at least one coupling mechanism 52.

As depicted in FIGS. 1 and 5, the cold section 16 may be configured to selectively cool and dehumidify a second material 56 via the cold compartment 18. As explained further below, the cold section 16 may be configured to form ice within the at least one ice storage container 42 via an ammonia-water absorption cycle. In this way, the exterior surfaces of the at least one ice storage container 42 may be relatively cool, such as slightly above 32 degrees F. As explained above, the at least one ice storage container 42 may be arranged within the cold compartment 40 such that a space or gap extends about the exterior surface thereof, as shown in FIG. 5. In this way, the cold section 16 may be configured to selectively pass a relatively warm and/or moist second material 56 through the cold compartment 18 and about or over the at least one ice storage container 42 to cool and/or dehumidify the second material 56. For example, the second material 56 may pass through the cold compartment 40 and over or about the relatively cool exterior surfaces of the at least one ice storage container 42 such that the second material 56 is cooler upon exiting the cold compartment 40 as compared to entering the cold compartment 40. If the second material 56 is a relatively warm gas (e.g., air) that includes moisture, contact of the relatively warm and moist gas 56 with the relatively cold exterior surfaces of at least one ice storage container 42 would both cool the gas 56 and condense the moisture in the gas 56 (i.e., dehumidify the gas 56). As discussed above, the condensed moisture from the gas would drain out from the cold compartment 40 via the sloped floor portion 44 and drain aperture 46 of the cold compartment 40. It is noted that the second material 56 may be any material capable of being passed through the cold compartment 40, such as a gas other than air or a liquid material.

For example, in an air conditioning and/or refrigeration configuration of the system 10 (and/or turbine-based power generation configuration, as discussed further below) the second material 56 may be relatively warm moist air, and the system 10 may include at least one fan or blower that is configured to draw or force the air 56 through the cold compartment 40 and over or about the relatively cool exterior surfaces of the at least one ice storage container 42 to lower the temperature of the air 56 below its dew point and condense moisture therein. The cooled and dehumidify air 56 may then be supplied to an area for air conditioning and/or refrigeration purposes (or passed to a compressor for turbine-based power generation, as explained further below).

As noted above, the cold section 16 may be configured to form ice 70 within the at least one ice storage container 42 via an ammonia-water absorption cycle 80 to cool the cool exterior surfaces of the at least one ice storage container 42 and, thereby, selectively cool and dehumidify (and/or condense) the second material 56. FIGS. 1 and 8-11 illustrate an exemplary configuration of the at least one ice storage container 42 to produce such ice via the ammonia-water absorption cycle 80.

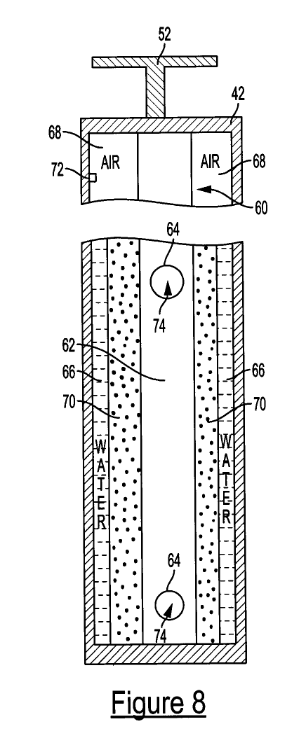

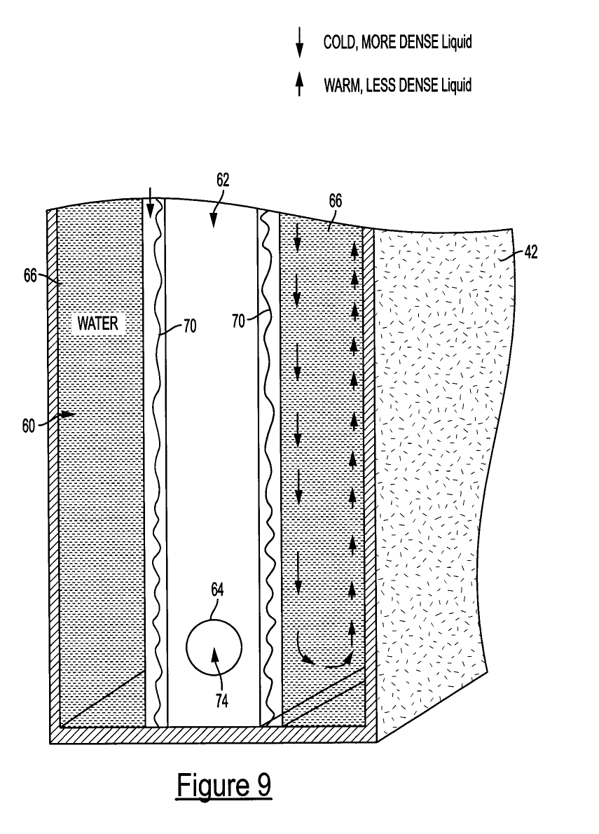

As shown in FIGS. 8 and 9, the at least one ice storage container 42 may form a substantially airtight or sealed cavity 60. An evaporation framework or plate 62 and a piping system 64 coupled thereto may be housed within a middle portion of the width of the cavity 60 of the at least one ice storage container 42, as shown in FIGS. 9-11. The piping system 64 may form a serpentine passageway for the flow of ammonia and hydrogen 74 of the ammonia-water absorption cycle 80. The inlet to the piping system 64 may be provided on the same side of the at least one ice storage container 42 as the outlet of the piping system 64, as shown in FIGS. 8, 10 and 11.

The cavity 60 of the at least one ice storage container 42 may also contain water or another material 66. For example, as shown in FIGS. 8 and 9, water 66 may be provided at least on opposing sides of the evaporation plate 62 and piping system 64 across the width of the cavity 60. However, as shown in FIG. 8, the cavity 60 may not be filled completely with the water 66. Instead, a head space or airspace 68 may be provided between the water 66 and the upper limit of the cavity 60. In this way, at least the majority of the evaporation plate 62 and piping system 64 may be submerged within the water 66.

The system 10 may also be configured such that a mixture of ammonia and hydrogen gas 74 of the ammonia-water absorption cycle 80 flowing into the piping system 64 enters as a liquid. Due to the presence of hydrogen, however, the ammonia vaporizes as it flows through the piping system 64 and, in the process, extracts heat from the water 66 that surrounds the evaporator plate 62 and/or piping system 64. The system 10 is configured that the flow of the ammonia and hydrogen 74 through the piping system 64 is at temperatures well below the freezing point of water. As such, when enough heat is removed from the surrounding water 66, ice 70 may be formed on the evaporation plate 62 and/or piping system 64 within the at least one ice storage container 42. As shown in FIG. 9, as the water 66 proximate to the evaporation plate 62 and/or piping system 64 is cooled it sinks, the warmer water 66 distal or spaced to the evaporation plate 62 and/or piping system 64 rises. In this way, the water 66 may circulate on the opposing sides of the evaporation plate 62 and/or piping system 64.

The airspace 68 may allow for the formation of the ice 66 within the cavity 60 without acting against the exterior walls of the at least one ice storage container 42. However, as the water 66 in the at least one ice storage container 42 freezes into the ice 70, it will compress the air 68 as the less dense ice 70 occupies more space than the liquid water 66 it came from. As a result, the at least one ice storage container 42 are configured to maintain their integrity, with some margin, from the peak internal pressure that would correspond to all the water 66 within the cavity 60 being turned into ice 70. In some embodiments, the system 10 may include a pressure sensor 72 within the cavity 60 of the at least one ice storage compartment 42 such that the control system 17 can monitor such interior pressure and modify the system 10 accordingly, as shown in FIG. 8.

In some embodiments, the control system 17 may be configured to regulate the flow rate of the ammonia 74 of the ammonia-water absorption cycle 80, and therefore the ice 70 formation, and the rate that the warm second material 56 is passed through the at least one ice storage container 42. The control system 17 may adjust the flow rate of second material 56 and/or the ammonia 74 so that the heat added to the whole system balanced the heat removed by melting ice 70. For example, control system 17 may be configured to control the cold section 16 (and potentially the hot section 14) such that the cold section 16 utilizes the ammonia-water absorption cycle 80 to form the ice 70 as a continuous ice making process while previously-formed ice 70 contained within the at least one cold compartment 40 melts. In such an arrangement, newly formed ice 70 would be melted as it was formed. In some embodiments, the control system 17 may be configured such that cold section forms ice at substantially the same rate as previously-formed ice therein melts, such that no net ice is formed in the at least one ice storage container. In such an arrangement, the net result would be “an iceless, ice storage system 10”, which is likely to be more compact than other ice-making designs. In another configuration, the control system 17 may allow an ice 70 build-up on the evaporation plate 62 and piping system 64 within a pre-designated ice 70 thickness. This built-up ice 70 could be utilized later to boost the air conditioning capability of the system 10, such as during subsequent peak outdoor temperatures, for example. In this way, the control system 17 may configure the system 10 such that the cold section forms a bulk of ice 70 at a first time period in the at least one ice storage container 42 to cool the second material 56 during a second time period subsequent to the first time period.

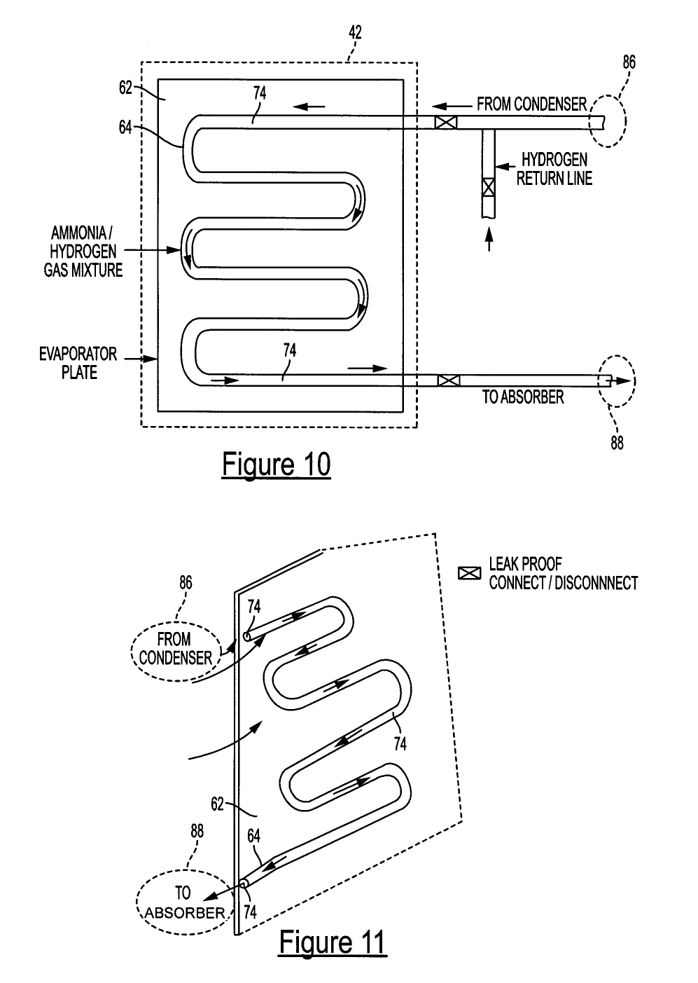

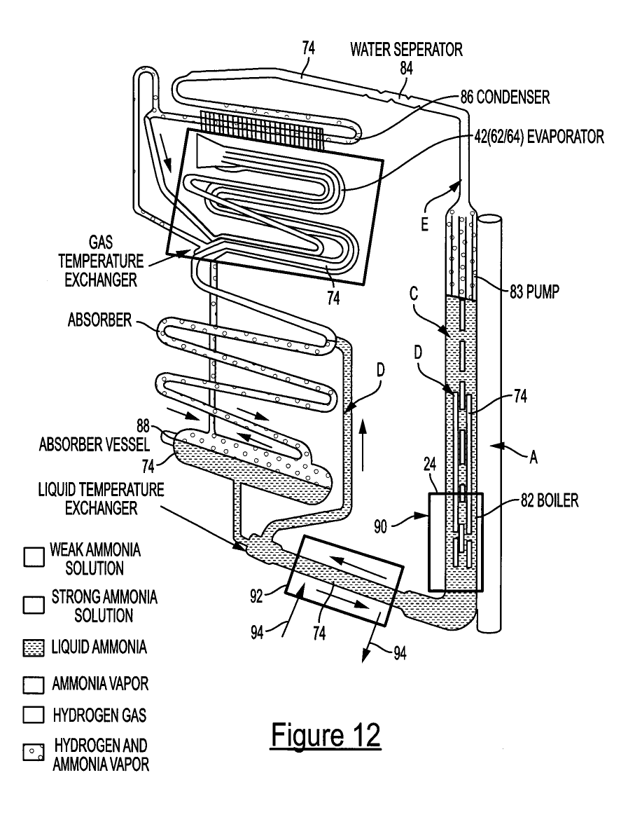

As noted above and shown in FIG. 1, the system 10 may be configured to selectively heat ammonia 74 (and potentially hydrogen and/or water) of the ammonia-water absorption cycle 80 to drive the cycle 80 and form the ice 70 via the first electrical power source 24 and/or heat from the hot section 14 or hot compartment 18. As indicated in FIGS. 10-14, the ammonia-water absorption cycle 80 may include several components or aspects. As depicted in FIG. 12, the cycle 80 includes a boiler portion 82, a separator 84, a condenser 86, the at least one ice storage container 42 (specifically, the evaporation plate 62 and piping system 64) which acts as an evaporator portion, and an absorber portion 88.

With reference to FIGS. 10-14, the cycle 80 may be operated by applying heat to the boiler portion 82, which may include a mixture 74 of ammonia and water. Traditionally, such heat applied at the boiler portion may be produced by burning a fossil fuel. However, the system 10 may heat the boiler portion 82, and thereby, the mixture 74 of ammonia and water therein, via an electrical heating coil 90 coupled to the piping of the boiler portion 82 carrying the ammonia mixture 74. In some embodiments, the electrical heating coil 90 may be powered by the first electrical power supply 24 (e.g., DER power 26 and/or off-peak grid electricity 28), as shown in FIGS. 1, 2 and 12.

The cycle 80 may be charged with a quantity of ammonia, water, and hydrogen. These may be at a sufficient pressure to condense the ammonia at a temperature for which the system 10 is designed. Starting with a weak solution of ammonia 74 (a mixture of some ammonia and water) in the boiler portion 82, the cycle 80 may be configured to separate the ammonia 74 from the water, as shown in FIG. 12. Some of this separation may take place in the boiler portion 82. When heat is supplied to the boiler portion 82 via the electrical coil 9, some ammonia-water separation may occur as bubbles of ammonia gas may be produced. Such ammonia bubbles may rise and carry with them some quantity of weak ammonia solution through a siphon pump portion 83. This weak solution 74 may pass into a portion (D) of the piping in the boiler portion 82, while ammonia vapor 74 may pass into a vapor pipe portion (E) and travel to the water separator portion 84, as shown in FIG. 12. The water separator portion 84 may be configured to condense any water vapor in the ammonia vapor 74, and such condensate may flow back into the boiler portion 82 via gravity, thereby dry ammonia vapor 74 will then pass to the condenser portion 86, as shown in FIG. 12.

The system 10 may be configured to circulate air over the fins of the condenser portion 86 to remove heat from the ammonia vapor 74. This ammonia vapor 74 may then condense into a liquid, that flows into the at least one ice storage container 42 (specifically, the evaporation plate 62 and piping system 64), which acts as an evaporator portion of the cycle 80. The piping system 64 coupled to the evaporation plate 62 of the at least one ice storage container 42 (i.e., the evaporator portion of the cycle 80) is supplied with this ammonia liquid 74 and with hydrogen gas, as depicted in FIGS. 10-14.

Within the evaporator portion (i.e., within the piping system 64 of the at least one ice storage container 42), the hydrogen gas may pass across the surface of the ammonia 74. In such a configuration, the hydrogen gas may lower the ammonia vapor 74 pressure sufficiently to allow the liquid ammonia 74 to evaporate. The evaporation of the ammonia 74 may extract heat from the piping system 64, and thereby the evaporation plate 62 coupled thereto (and the water 66 and/or ice 70 in contact with the piping system 64 and the evaporation plate 62 within the at least one ice storage container 42). In this way, the heat removed by the evaporation of ammonia 74 within the piping system 64 (i.e., the evaporator portion) may cause the water 66 within the at least one ice storage container 42 to first reach 32 degrees F., and with more cooling by the evaporating ammonia, turn this 32 degree F. water into the ice 70. Further, as the piping system 64 is coupled to the evaporation plate 62, the evaporation plate 62 also may become very cold because of its direct contact with the ammonia/hydrogen gas.

As indicated in FIGS. 10-14, after the ammonia and hydrogen gases 74 exit from the evaporator portion (i.e., the piping system 64 of the at least one ice storage container 42), the cycle 80 may separate the hydrogen gas from the ammonia gas via the absorber portion 88, which may be partially filled with water. A continuous trickle of weak ammonia solution 74 may enter the upper portion of the absorber portion, which may be fed by gravity from the portion (D) of the boiler portion 82. This weak solution 74 may flow down through the absorber portion 88, and come into contact with the mixed ammonia and hydrogen gases 74. Because ammonia has such a high affinity for water, this weak solution of ammonia 74 may readily absorb the ammonia 74 from the mixture of ammonia and hydrogen gas coming from the at least one ice storage container 42 (i.e., the evaporator portion) of the cycle 80. The absorption of the ammonia 74 into the water may leave the hydrogen gas free to rise through the absorber 88 and return to the at least one ice storage container 42. Thus the hydrogen 74 may circulate continuously between the absorber portion 88 and the at least one ice storage container 42 (i.e., the evaporator portion) of the cycle 80.

The ammonia solution 74 produced in the absorber portion 88 may flow down to an absorber vessel and ultimately pass on to the boiler portion 82, thus completing the full cycle 80 of operation, as indicated in FIGS. 10-14. However, as shown in FIGS. 1, 12, 14 and 15 the system 10 may be configured such that the weak solution of ammonia 74 that leaves the absorber portion 88 passes through an enclosed heating chamber or heat exchanger 92 to heat the weak ammonia solution 74. As shown in FIGS. 1, 12 and 15, the heat exchanger 92 may be heated by material 94 that is heated by passing through the hot compartment 14 (such as the first material 32). The material 94 (e.g., the first material 32 or a separate and distinct material or flowpath) that is heated by the hot compartment 14 may be mixed with recirculated air, and then fed into the heat exchanger 92, through which the weak solution of ammonia 74 that leaves the absorber portion 88 may be piped. In an alternative embodiment, the system 10 may be configured to heat the weak solution of ammonia 74 that leaves the absorber portion 88 by piping the weak ammonia solution 74 through the hot compartment 14.

After the weak solution of ammonia 74 that leaves the absorber portion 88 is heated by the heat from the hot compartment 14 (e.g., via the heat exchanger 92), the solution may flow back the boiler portion 82 and further heated by the electric coil 90. The amount of energy transferred to the weak ammonia solution 74 by the heat exchanger 92 may be varied by the control system 17. For example, the control system 17 may change the temperature of the material 94/32 that flows over the piping that contains the weak ammonia solution 74 within the heat exchanger 92 by altering the ratio of recirculated air to the very hot material that exits the hot compartment 14.

As described above, the system 10 provides for at least two separate and distinct modes to heat the ammonia 74 of the ammonia-water absorption cycle 80. In one mode, the ammonia 74 is heated by the first electrical power supply 24 (e.g., off-peak grid electricity 28 and/or DER power 26), such as via an electrical heating coil 90 as shown in FIGS. 1, 2 and 12. In the second mode, the weak ammonia solution 74 that leaves the absorber portion 88 passes through a heat exchanger 92 that is heated by a material 94 that has been heated by flowing through the hot compartment 14, as shown in FIGS. 1, 12 and 15. As also discussed above, the system 10 may be configured to moderate the temperature of the material 94 that has passed through the hot compartment 14 and heats the weak ammonia solution 74 via the heat exchanger 92 by mixing it with cooler material, such as cooler air. The resultant mix of the hot material 94 and the cooler material may flow through the heat exchanger 92 to heat the ammonia solution 74. In some embodiments, the hot material 94 may be as hot as about 1,300 degrees F. upon exiting the hot compartment 14, but the cooler material mixed with the hot material 94 may lower the temperature of the resultant mix to within the range of about 350 degrees F. and about 400 degrees F., for example, upon entering the heat exchanger 92. This relatively moderately heated resultant mix (e.g., air) may be achieved by the control system 17 blending the hot material 94 exiting the hot compartment 18 with room temperature air to form the resultant mix, and then utilizing one or more blowers to direct the resultant mix to and through the heat exchanger 92.

The system 10 may be configured to control the flow of the first material 32 and/or the material 94 with respect to the hot compartment 18, and/or the second material 56 with respect to the cold compartment 40, and/or the flow of ammonia 74 through the ammonia-water absorption cycle 80. In some embodiments, the system 10 may include at least one damper (not shown) controlled by the control system 17 to control the flow of the first material 32 and/or the material 94 with respect to the hot compartment 18, and/or the second material 56 with respect to the cold compartment 40. For example, control system 17 may determine that air conditioning is not needed (e.g., due to the outdoor temperature of the location of the system 10, such as during a winter), and control the at least one damper to isolate the heat exchanger 92 that heats the ammonia 74. Isolating the heat exchanger 92 may include preventing or otherwise stopping the flow of the material 94 through the heat exchanger 92, for example. As another example where the control system 17 determines that air conditioning is not needed, the control system 17 may prevent or otherwise stop the heating of the ammonia 74 by the first electrical power source 24 (e.g., via the electrical heating coil 90). It is noted that if the control system 17 determines that air conditioning is not needed, the system 10 may still provide the space heating and/or hot water production. However, the flow of the first material 32 and/or the material 94 with respect to the hot compartment 18, and/or the second material 56 with respect to the cold compartment 40, may be controlled by the control system 17 to vary or not provide the space heating and/or hot water production, if desired.

In some embodiments, the system 10 may be configured such that the control system 17 may determine a condition or time period in which the need for air conditioning is precluded, and may thereby deactivate or isolate the cold section 16 and the heat exchanger 92 (and thereby the ammonia-water absorption cycle 80). Similarly, in some embodiments the system 10 may be configured such that the control system 17 may determine a condition or time period in which the need for space heating is precluded, and may thereby deactivate or isolate a flow of the first material 32, while maintaining operation of the hot compartment 18 and a flow of the first material 32 to continue production of hot water therefrom.

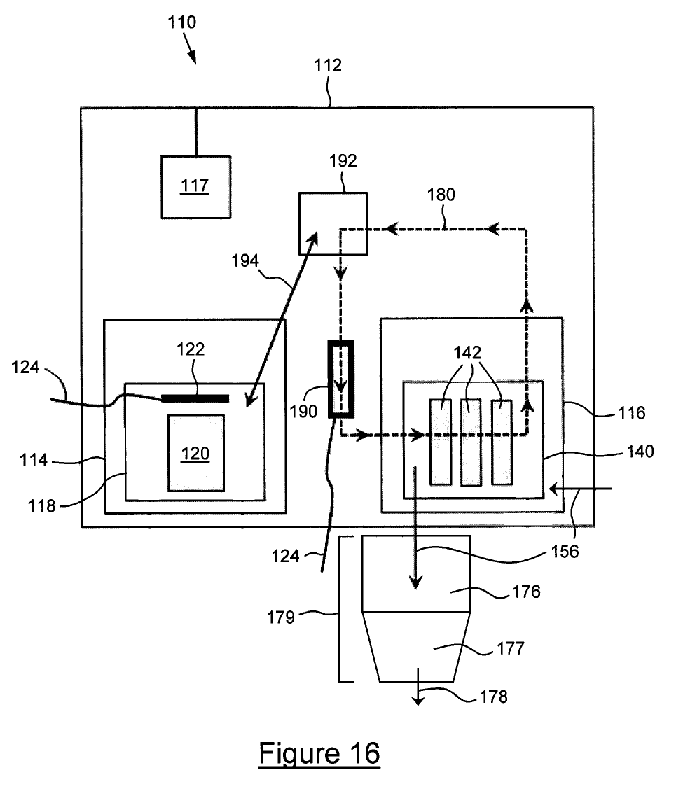

FIG. 16 illustrates another energy storage system of the present disclosure and generally indicated by reference numeral 110. The energy storage system 110 of FIG. 16 is similar to the energy storage system 10 of FIGS. 1-15, and therefore like reference numerals preceded by the numeral “1” are used to indicate like elements, functions, aspects or the like (and therefore the corresponding description thereof, including alternative embodiments, presented above with respect to energy storage system 10 of FIGS. 1-15 may equally apply to energy storage system 110 of FIG. 16). The energy storage system 110 differs from the energy storage system 10 in that it is specifically configured to provide cool dry air 156 to a compressor 176 of a turbine-based 178 electrical power generation system 179, thereby raising the efficiency of the turbine 178. The energy storage system 110 may thereby be referred to as an electricity in and cool dry air out (EI-CDAO) configuration. The energy storage system 110 may be located or positioned proximate to one or more turbine 178 inlets, for example.

As shown in FIG. 16, the cold section 116 may be configured to pass air 156 through the at least one ice storage container 142 to cool and dehumidify the air, as discussed above. The system 110 may be further configured to pass or feed the cooled and dried air 156 exiting the at least one ice storage container 142 to a compressor 176, as shown in FIG. 16. The compressor 176 may be part of an electrical power generation system 179 such that the compressor 176 compresses the cooled and dried air 156 and supplies such to a turbine 177. The turbine 177 may be configured to power a generator (not shown) that is configured to generate electrical power. After utilized by the turbine 177, the cooled and dried air 56 may be exhausted 178, such as into the atmosphere, by the turbine 177, as shown in FIG. 16. In some embodiments, the turbine-based generator system 179 includes a gas turbine 177 that powers an electric generator, and the compressor 176 compresses the cooled and dehumidified air 156 and feeds it to the gas turbine 177.

As also shown in FIG. 16, as the energy storage system 110 may be specifically configured to provide cool dry air 156 to a compressor 176 of a turbine-based 178 electrical power generation system 179, the hot section 114 may or may not be configured to pass material (such as the first material 132) through the hot compartment 118 to heat the material and provide space heating and/or hot water therefrom. However, the hot section 114 may be configured to heat the ammonia 174 of the ammonia-water absorption cycle 180 to drive the cycle 180 and form the ice 170 within the at least one ice storage compartment 142.

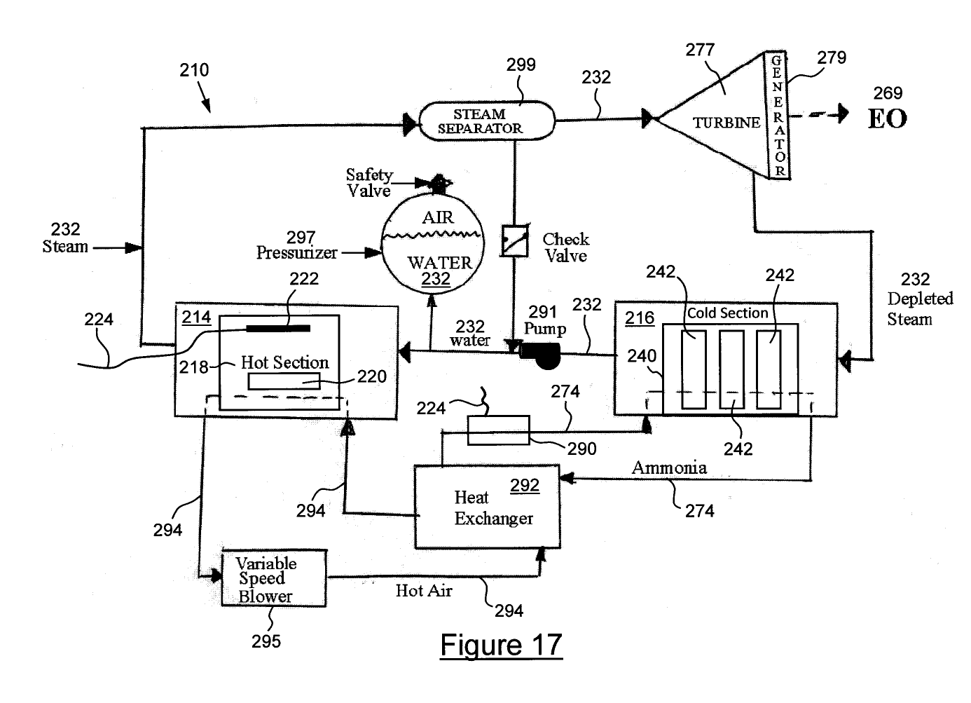

FIG. 17 illustrates another energy storage system of the present disclosure and is generally indicated by reference numeral 210. The energy storage system 210 of FIG. 17 is similar to the energy storage system 10 of FIGS. 1-15 and energy storage system 110 of FIG. 16, and therefore like reference numerals preceded by the numeral “2” are used to indicate like elements, functions, aspects or the like (and therefore the corresponding description thereof, including alternative embodiments, presented above with respect to energy storage system 10 of FIGS. 1-15 and energy storage system 110 of FIG. 16 may equally apply to energy storage system 210 of FIG. 17). The energy storage system 210 differs from the energy storage systems 10 and 110 in that it is specifically configured to produce electricity, such as during peak demand periods. The energy storage system 210 may thereby be referred to as an electricity in and electricity out (EI-EO) configuration. The energy storage system 210 may be located or positioned proximate to community power grid substations, critical facilities within a traditional power grid, power plants, wind farms or electric vehicle charging stations, for example.

As shown on FIG. 17, the energy storage system 210 is configured to store off-peak electricity 224 as heat in the thermal energy storage material 220 of the hot section 214 and as the ice 170 of the cold section 216. As also shown in FIG. 17, the system 210 is configured to return the stored off-peak electricity 224 to a grid power system 269 during peak demand periods, for example, via a turbine 27 and generator system 279.

The system 210 may utilize a closed water/steam loop to create steam 232 from input water 232 via the hot section 214 to drive a steam turbine 277 and generator 279 to produce electricity 269. The closed water/steam loop of the system 210 may further condense the steam 232 utilized and exhausted by the turbine 277 via the cold section 216, and to supply the condensed stream (i.e., water) to the hot section 214 to create the input steam 232 and complete the water/steam loop or cycle.

The steam 232 utilized and exhausted by the turbine 277 may be passed through the at least one ice storage compartment 242 of the cold compartment 240 of the cold section 216 to produce the input water 232. As discussed above, the cold section 216 may be configured to form ice 270 within the at least one ice storage container 242 via an ammonia-water absorption cycle 280 driven at least in part by heated air 294 produced by the hot section 214. As shown in FIG. 17, the system 210 may include a blower or fan 295 to drive the flow of air 295 through the hot compartment 218 of the hot section 214 and the heat exchanger 292 to heat the ammonia 274 and thereby, at least partially drive the ammonia-water absorption cycle 280.

As shown in FIG. 17, the input water 232 produced from condensing the steam 232 exhausted by the turbine 277 via the cold section 216 may be pumped via a pump 291 to and through the hot compartment 218 of the hot section 214 to produce steam 232 therefrom. As the water/steam cycle of the system 210 may be a closed loop, the system may include a pressurizer 297 that includes an airspace in fluid connection with the loop (i.e., fluid connection with the water/steam 232). As shown in FIG. 17, the pressurizer 297 may be positioned between the pump 291 and the hot section 214. The pressurizer 297 may be configured to control the pressure of the closed loop within a predefined limit or range.

The steam 232 produced by the hot compartment 218 of the hot section 214 may be directed to a steam separator 299, as shown in FIG. 17. The steam separator or moisture separator 299 may be configured to separate water droplets from the steam 232, and direct the separated water therefrom back to the hot section 214.

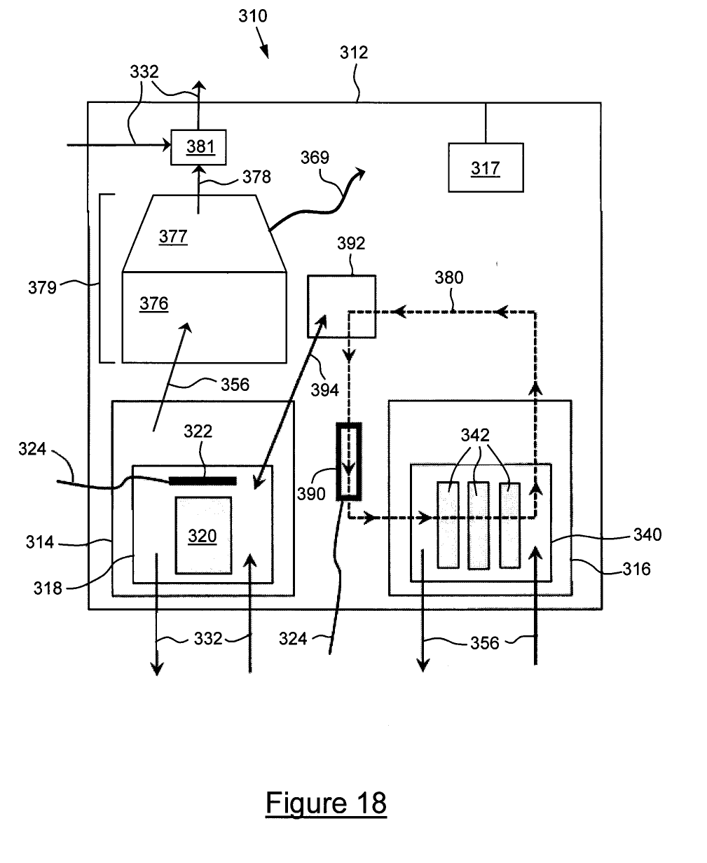

FIG. 18 illustrates another energy storage system of the present disclosure and is generally indicated by reference numeral 310. The energy storage system 310 of FIG. 18 is similar to the energy storage system 10 of FIGS. 1-15, the energy storage system 110 of FIG. 16, and the energy storage system 210 of FIG. 17, and therefore like reference numerals preceded by the numeral “3” are used to indicate like elements, functions, aspects or the like (and therefore the corresponding description thereof, including alternative embodiments, presented above with respect to energy storage system 10 of FIGS. 1-15, the energy storage system 110 of FIG. 16, and the energy storage system 210 of FIG. 17 may equally apply to energy storage system 310 of FIG. 18).

As shown in FIG. 18, in addition to storing input electricity 324 as heat (e.g., direct current input electricity 324, the thermal energy storage material 320 may be utilized to produce or provide alternating electric current. For example, as shown in FIG. 18 direct current input electricity 324, such as direct current provided from a DER (e.g., a solar/photovoltaic system, wind system, etc.) may be utilized to heat the thermal energy storage material 320 via a heating mechanism 322, as discussed above. Specifically, the electrons from the DER (such as PV produced electrons, for example) as a direct current may be utilized to heat the thermal energy storage material 320 via the heating mechanism 322. The direct current input electricity 324 may be fed or provided separately to the heating mechanism 322 than an alternating current input electricity 324 (i.e., an alternating current source of electrons) such that there is no interference therebetween. In some embodiments, the direct current input electricity 324 and the alternating current input electricity 324 may be electronically separated. In some embodiments, the direct current input electricity 324 may provide a direct current to the heating mechanism 322 during a first time interval, and the alternating current input electricity 324 may provide an alternating current to the heating mechanism 322 during a second time interval that is different than the first time interval. In one example, the direct current input electricity 324 may provide a direct current to the heating mechanism 322 during the daytime or during peak rates (and/or when the DER system is able to provide sufficient current/power), and the alternating current input electricity 324 may provide an alternating current to the heating mechanism 322 during night or off-peak rates (and/or when the DER system is not able to provide sufficient current/power).

In some embodiments, the system 310 may be configured such that the thermal energy storage material 320, which may normally or typically be utilized in cold weather for space heating, is electrically heated with the input electricity 324 (e.g., via a direct current input electricity and/or an alternating current input electricity). Heating of the thermal energy storage material 320 may occur during warm weather or otherwise when the hot section 314 is not needed for space heating and/or hot water production, or may occur during cooler or cold weather when the hot section 314 is needed for space heating and/or hot water production. As shown in FIG. 18, the heated energy storage material 320 may then be utilized to create electrical current or electricity via an electrical power generation system 379, such as a turbine-generator system.

The system 310 may be configured such that a flow of hot air 356 created by blowing intake air over the hot thermal energy storage material 320 is fed or directed to the electrical power generation system 379 (e.g., a turbine-generator system), as shown in FIG. 18. The electrical power generation system 379 may include a turbine 376, as shown in FIG. 18. In some embodiments, the power generation system 379 may include a compressor. In such embodiments, the compressor may compress the heated air 356 and supply it to the turbine 376. In some other embodiments, the power generation system 379 may not include a compressor.

The turbine 376 may be configured to utilize the hot air 356 heated by the thermal energy storage material 320 to produce torque or rotational power. The torque produced by the turbine 376 via the hot air 356 may be configured to power a generator 377 of the power generation system 379, as shown in FIG. 18. The generator 377 may be configured produce electrical power 369 via the rotational energy, as shown in FIG. 18. In some embodiments, the generator 377 may be configured to produce alternating current electricity. In some other embodiments, the generator 377 may be configured to produce direct current electricity 369. In such embodiments, the generator 377 may include an AC-DC converter configured to convert the output direct current 369 to alternating current. In these ways, for example, the input energy 324 (e.g., direct electric current) may be stored as heat in the thermal energy storage material 320, and the electrical power generation system 379 may utilize heated air 356 heated by the electrical power generation system 379 to generate electric current 369, such as alternating electric current.

As shown in FIG. 18, relatively hot exhaust 378 may be output by the power generation system 379, such as form the turbine 376 and/or the generator 377. The system 310 may utilize the relatively hot exhaust 378 to heat a material, such as a fluid and/or a gas. In some embodiments, the system 310 may include a heat exchanger 381 that is configured to utilize the relatively hot exhaust 378 to heat another material. For example, the heat exchanger 381 may configured to heat a flow 332 of water via the relatively hot exhaust 378 to produce hot water, which may be utilized for space heat and/or hot domestic water. As another example, the heat exchanger 381 may configured to heat a flow 332 of air via the relatively hot exhaust 378 to produce hot air, which may be utilized for space heat.

By being configured with the electrical power generation system 379, the system 310 may thereby be configured to provide air conditioning, space heat, hot water, and/or a source of electricity 369, such as a source of alternating current. The output current 369 can may be utilized in a myriad of differing ways. For example, the output current 369 may be utilized to power heat pumps or for other end use devices. The inclusion of the electrical power generation system 379 with the system 310 may also be effective in reducing the impacts of cyber-attacks on the electrical power grid. Still further, if the system 310 produces more electricity or electrons than is needed via a DER (e.g., photovoltaics), such as in the low cooling and heating demand periods in the spring and fall when neither space heating or air conditioning are needed, the excess electricity may be utilized to heat the thermal energy storage material 320 via a heating mechanism 322 and, ultimately, generate the electric current 369 via the electrical power generation system 379. In this way, any excess electricity or electrons that are produced, such as via a DER (e.g., photovoltaics), may not be wasted (e.g., dumped to the atmosphere), but rather stored in the thermal energy storage material 320 as heat, and later converted back to electrical current 369 via the electrical power generation system 379.

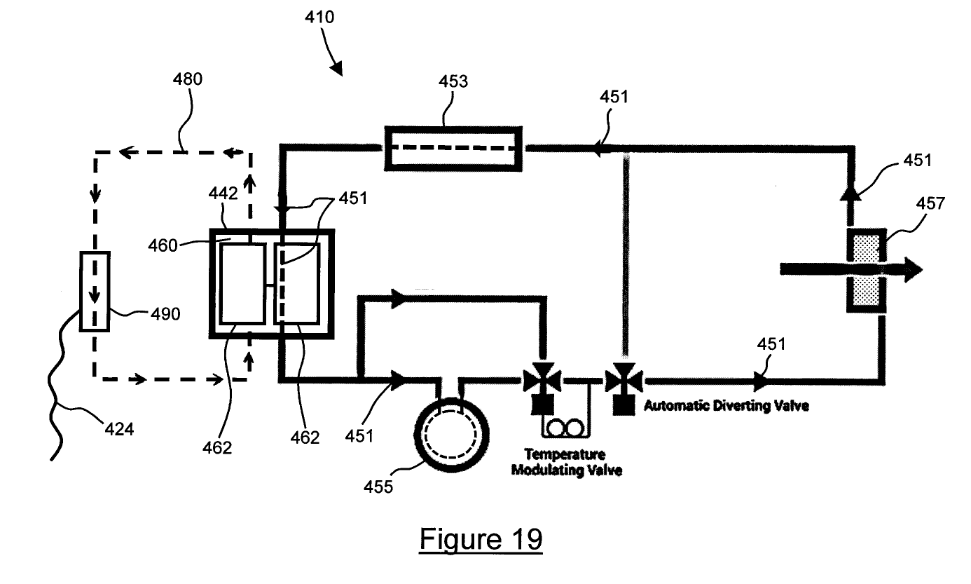

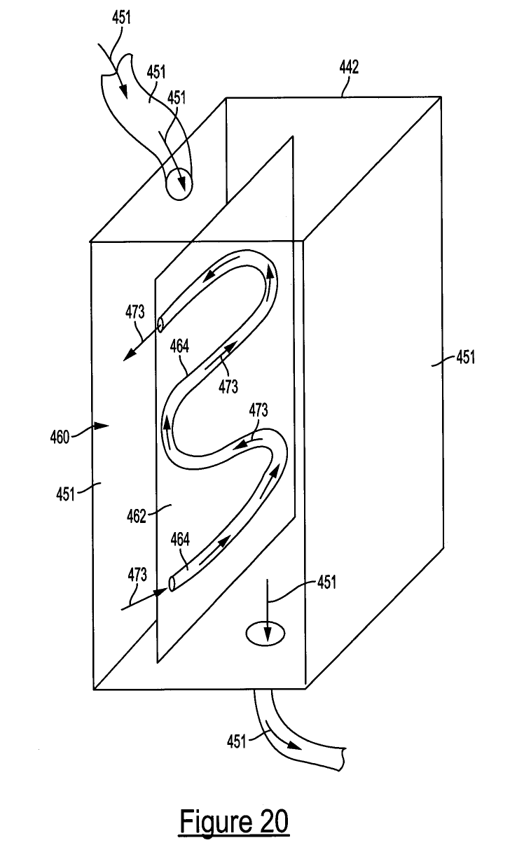

An improved thermal energy storage system 410 of the present disclosure is depicted shown in FIGS. 19 and 20 and is generally indicated by reference numeral 410. The system 410 may be configured as an ice storage system that produces ice during a first time interval (i.e., an ice charging mode) and utilizes the stored ice to provide cooling (e.g., air conditioning) during a second time interval (i.e., an ice melt mode). For example, the system 410 may be configured to utilize electricity to make ice during off-peak electricity time periods, and then utilize and melt the ice for peak electricity time period cooling needs, effectively shifting the electric load and avoiding higher price energy and demand.

The system 410 includes cooling equipment and at least one energy or ice storage tank 455 to produce and store ice during the ice charging mode and shift all or a portion of a user's electric use for cooling needs during the ice melt mode to off-peak time periods. The system 410 may make use of a flow of coolant or anti-freeze solution 451, such as a mixture of ethylene glycol and water, to achieve the relatively low temperatures and form ice from water. In some embodiments, the system 410 may utilize a coolant flow 451 of 60% ethylene glycol and 40% water mix. The flow of coolant 451 may be a series flow, storage upstream design, chiller upstream or parallel flow. The system 410 may be a closed loop system such that the coolant 451 flows through a closed loop.

As shown in FIG. 19, the system 410 may include an ice-making chiller 453 that is configured to produce the low temperature coolant solution 451 flowing in the closed loop. The cooling loop, and thereby the cooled coolant 451, passes through an ice storage tank 455 to freeze a liquid 459 (e.g., water) therein, as shown in FIG. 19. The chiller 453 may be a refrigeration mechanism including a compressor, evaporator, condenser and/or at least one pump, for example. The chiller 453 may be configured to substantially lower the temperature of the coolant 451, such as at least below the freezing temperature of the liquid 459 within the ice storage tank 455 (e.g., below the freezing point of water). In some embodiments that utilize glycol or a glycol-mixture as the coolant 451, the chiller 453 of the system 410 may be configured to cool the coolant 451 to a temperature within the range of 20° F. to 22° F.

As also shown in FIG. 19, the cooling loop, and thereby the cooled coolant 451, may pass through a heat exchanger or other mechanism 457 configured to utilize the cooled coolant 451 (cooled by the chiller 453 and/or the ice 459 within the ice storage tank 455) to cool a material, such as a flow of air and/or water. In some embodiments, the heat exchanger 457 may be configured to pass a flow of air over the flow of the cold coolant 451 to cool the air for air conditioning and/or refrigeration purposes, for example.

In use, the system 410 may cool the coolant 451 via the chiller 453 in the ice charging mode during the night time or off-peak electricity pricing. For example, the chiller 453 may operate during non-peak hours cooling a glycol solution 451 to sub-freezing temperatures. The system 410 may pump the coolant 451 through the closed loop while the chiller 453 cools the coolant 451. During the ice charging mode, the heat exchanger 457 may or may not be utilized to cool a flow of material. The coolant 451 that is cooled by the chiller 453 may flow through the closed loop and be directed, at least in part, to and through the ice storage tank 455. In this way, during the ice charging mode, the system 410 may circulate the cooled coolant 451 to/through the ice storage tank 455.

As shown in FIGS. 18 and 19, the coolant 451 may pass through a cold compartment or heat exchanger 442 of the system 410 on its path to the ice storage tank 455. The cold compartment 442 of the system 410 may be a substantially sealed container that includes a flow of the coolant therethrough 451. As also shown in FIGS. 18 and 19, the cold compartment 442 may include an at least one evaporator plate 462 of an ammonia absorption cycle 480 of the system 410. The ammonia absorption cycle 480 and its components and functions of the system 410 may be substantially similar to the ammonia absorption cycle 80 of FIGS. 1-15 described above, and therefore like reference numerals preceded by the numeral “4” are used to indicate like elements, functions, aspects or the like (and therefore the corresponding description thereof, including alternative embodiments) which equally apply to ammonia absorption cycle 80 of FIGS. 18 and 19.

The ammonia absorption cycle 480 may differ from the ammonia absorption cycle 80 in that as opposed to the evaporator plate 462 and associated piping 464 directing the flow of ammonia 473 being positioned in ice storage containers to produce ice, the evaporator plate 462 and associated piping 464 are positioned within the cold compartment 442 with the flow of coolant 451 flowing therethrough. As the coolant 451 flows through the cold compartment 442 and over or about the evaporator plate 462 and associated piping 464, the coolant 451 (e.g., a glycol mixture) gets cooled by the evaporator plate 462 and associated piping 464 due to the very cold ammonia of the ammonia absorption cycle 480. As noted above, ammonia has a boiling point of about minus 33.3 degrees C. and a melting point of minus 77.7 degrees C. The operating temperatures of the ammonia 473 of the ammonia absorption cycle 480 flowing through the piping 464 associated with the evaporator plate 462 are thereby very low and below the normal operating range of the coolant 451 (e.g., a glycol mix) that flows past the submerged evaporator plate 462 and associated piping 464 in the cold compartment 442, thereby lowering the temperature of the coolant 451. The cold compartment 442 may be positioned anywhere along the closed loop of the flow of the coolant 451 cooling loop, such as between the chiller 453 and the ice storage tank 455, or before the chiller 453 and the ice storage tank 455.

As explained further below, the system 410 thereby includes two distinct systems cooling systems or cycles—the ammonia-based system that provides cooling to the cold compartment 442 via the ammonia absorption cycle 480, and the coolant-based system (e.g., glycol-based system) that provides cooling to the a first material via the heat exchanger 457 via the flow of cold coolant 451 that is cooled by at least one of the chiller 453, the cold compartment 442 and/or the ice storage tank 455. The ammonia-based system and the coolant-based system may share equipment, such as control valves, chillers, instrumentation, and the control system discussed above. As discussed further below, the coolant-based system may operate as a batch process that operates the chiller 453 at night to produce ice within the ice storage tank 455, while the ammonia-based system may operate as a continuous system that works during the day using the ammonia absorption cycle 480 to continuously cool the coolant 451 of the coolant-based system. As noted above, the ammonia-based system may operate of DER, such as from a photovoltaic system.

For example, as shown in FIG. 19 the ice storage tank 455 of the system 410 may include one or more ice storage coil extending within the ice storage tank 455. The at least one coil may thereby direct the cold coolant 451 to circulate inside the storage tank 455. During an ice storage mode, such as during off-peak electric time periods, the coolant 451 may flow through the at least one coil of the ice storage tank 455 at a temperature below the liquid 459 freezing point such that ice is formed within the tank 455 on or around the external surfaces of the coils. In this way, the ice build process may occur during an electric utility's off-peak time period, when energy and demand costs are very low. The liquid (e.g., water) 459 within the ice storage tank 455 may be a fixed volume such that it never leaves the tank 455. In some embodiments, the storage tank 455 may be configured with a plurality of coils that are spaced relatively close to each other such that ice forms on the coils during an ice storage mode and bridges from coil to coil.

The amount of time to fully charge the storage tank 455 with batch of ice during an ice storage mode may depend, at least partially, on the size of the tank 455 and the temperature of the coolant 451. In some embodiments, it may take several hours for the storage tank 455 to fill with a batch of ice, such as within the range of about 6 to about 12 hours. The amount of ice created within the storage tank 455 during an ice storage mode may vary. For example, operation of an ice storage mode overnight may fill the storage tank 455 with at least about 65% ice, or 65% to 80% ice, or at least about 95% ice. The ice build may be considered complete during an ice storage mode when the liquid 459 within the storage tank 455 reaches a predetermined level.

After a batch of ice has been created within the ice storage tank 455 during an ice storage mode (e.g., during off-peak electricity time periods), the chiller 453 may turn off and the system 410 may operate in the ice melt mode (e.g., during off-peak electricity time periods). For example, the ice melt mode may operate during the day-time or peak electrical rate hours to circulate the coolant 451 through the cold compartment 442 and the ice storage tank 455 to cool coolant 451 and deliver the stored energy to a material (e.g., a flow of air) via the heat exchanger 457 (e.g., a flow of cool air for air conditioning and/or refrigeration needs). The combination of the cold compartment 442 and the ice storage tank 455 may cool the coolant 451 such that it is delivered at the proper temperature to the heat exchanger 457. The temperature of the coolant 451 may be controlled by at least one pump and/or valve to direct portions of the coolant 451 through the cold compartment 442 and/or the ice storage tank 455 depending upon the temperature of the coolant 451 and/or a user's cooling needs.

As the coolant 451 flows through the ice storage tank 455 during the ice melt mode, the ice within the ice storage tank 455 melts as the temperature differential between the chilled coolant 451 supply to the heat exchanger 457 and the chilled coolant 451 returned to the tank 455 increases. For example, as the coolant 451 is circulated through the heat exchanger 457, which may provide air conditioned air to various spaces, the coolant 451 may be heated and then cooled by the cold compartment 442 an the ice storage tank 455. However, the heat from the heated coolant 451 may melt the previously-produced (e.g., during off-peak hours)) batch of ice within the ice storage tank 455. During the ice melt cycle, the warmer returning coolant solution 451 is thereby circulated through the same ice coil circuits of the ice storage tank 455, and ice within the ice storage tank 455 is melted from the inside. Gradually, the stored ice within the ice storage tank 455 is thereby converted back to liquid form and the whole cycle starts over again during the next ice charging mode (e.g., the next off-peak time period). For example, the coolant 451 (e.g., a glycol mix) may freeze the liquid 459 within the ice storage tank 455 during the night, and during the warm hot subsequent day, the coolant 451 itself is cooled by the same ice that it had made before within the ice storage tank 455.

Further, the cold compartment 442 may also cool the warmed coolant 451 via the ammonia absorption cycle 480 in addition to the ice storage tank 455 during the ice melt mode. As noted above, the ammonia absorption cycle 480 may include a boiler portion 490 that may heat a mixture of ammonia and water via an electrical heating coil or other electrical means. The boiler portion 490 may thereby be powered by DER, such as photovoltaics, during an ice melt mode (e.g., during the day time or peak hours) to run the ammonia absorption cycle 480 and cool the cold compartment 442 to cool down the warmed coolant 451. Also, the cold compartment 442 may also cool the coolant 451 during the storage mode of the system 410 (e.g., during off-peak electricity time periods), such as from DER or off-peak electricity, to reduce the amount of work needed by the chiller 453.

To the extent that the ammonia absorption cycle 480 reduces the amount of ice that the chiller 453 needs produce during an ice storage mode, less grid based electricity may thereby need be purchased and wear and tear on the compressor may be reduced. Still further, since the ammonia absorption cycle 480 produces no greenhouse gases per kw-hr (e.g., when run on DER), the ammonia absorption cycle 480 of the system 410 may effectively reduce greenhouse gases as compared to if the displaced grid based electricity has some level of greenhouse gases/kw-hr. These savings at the point of use can be added to the longer term benefits available to electrical power utilities by having more off-peak capacity for other applications, such as for energizing electric vehicles. Still further, off-peak electricity may become more expensive as electrified space heating and hot water heating demands are added to the loads now served by the grid, and/or as the number of electric vehicles increased. As such, although off-peak electricity has a low price/kw-hr today, it may rise over time. However, no increase in the cost of electricity is expected to occur from DER, such as from installed residential photovoltaic systems. Therefore, if the ammonia absorption cycle 480 is run by such DER, the system 410 may help moderate price increases of electricity.

On a basic level, the thermal energy storage system 410 is based on proven technology that reduces chiller 453 size and shifts compressor energy, and condenser fan and pump energies, from peak electricity periods, when energy costs are high, to non-peak electricity periods, where electric energy is more plentiful and less expensive. However, there are additional benefits of the system 410 that may not be as obvious. For example, the ammonia absorption cycle 480 and cold compartment 442 may allow the chiller 453 to run or operate for shorter time periods to build particular batches of ice within the ice storage tank 455 as compared to similar thermal energy storage systems that do not include the absorption cycle 480 and cold compartment 442. Not only would the system 410 thereby potentially increase the operating life of the chiller 453 (e.g., the compressor thereof), the shorter ice charging time may be more compatible with time-of-use cost of electricity structures established by utilities (e.g., peak and off-peak prices). As another example, depending on the method of ice melt within the ice storage tank 455, the cooling fluid temperature can be substantially reduced when compared to a conventional chilled system. This colder fluid offers many design benefits that reduce the overall system's first cost and improve HVAC and process cooling performance, for example. Still further, the liquid 459 within the ice storage tank 455 remains static and goes through phase changes only. The liquid 459 is not circulated in the cooling loop or otherwise in the system 410. Since the system 410 is based on closed loops, the system 410 is relatively simple and can be run by relatively simple controls.

It is to be understood that the above description is intended to be illustrative, and not restrictive. Numerous changes and modifications may be made herein by one of ordinary skill in the art without departing from the general spirit and scope of the invention as defined by the following claims and the equivalents thereof. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Also, the term “operably connected” is used herein to refer to both connections resulting from separate, distinct components being directly or indirectly coupled and components being integrally formed (i.e., monolithic). Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I claim:

1. A passive energy storage system, comprising:
a hot section including a thermally insulated hot compartment therein comprises thermal energy storage material, the hot section being configured to heat the thermal energy storage material via at least a first electrical power source and to selectively pass a first material through the hot compartment to heat the first material; and
a cold section including a thermally insulated cold compartment with at least one ice storage container, the cold section being configured to form ice within the at least one ice storage container via an ammonia-water absorption cycle and to selectively cool and dehumidify a second material via the cold compartment,
wherein the system is configured to selectively heat ammonia of the ammonia-water absorption cycle to drive the cycle and form the ice via the hot compartment and a heating mechanism positioned exterior of the hot compartment powered by the first electrical power source, and
wherein the hot compartment and the at least one cold compartment are differing compartments that are thermally insulated from each other.

2. The system of claim 1, wherein the hot compartment is configured to heat the thermal energy storage material via at least the first electrical power source via conduction.

3. The system of claim 1, wherein the first electrical power source is alternating current from a grid-based off-peak electrical supply.

4. The system of claim 3, wherein the hot compartment is configured to heat the thermal energy storage material via at least a second electrical power source, and wherein the second electrical power source is direct current from a distributed energy resources (DER) system.

5. The system of claim 1, wherein the thermal energy storage material comprises a mass of ceramic and/or metal material.

6. The system of claim 1, wherein the first material is air, and wherein the hot section is configured to pass the air through the hot compartment to heat the air for use in space heating and/or heated water production.

7. The system of claim 1, wherein the first material is a fluid, and wherein the hot section is configured to draw the fluid through the hot compartment to heat the fluid for use in space heating and/or heated water production.

8. The system of claim 1, wherein the second material is air, and wherein the cold section is configured to pass the air through the cold compartment to cool and dehumidify the air for use in air conditioning and/or refrigeration.

9. The system of claim 1, wherein the second material is air, and wherein the cold section is configured to pass the air through the cold compartment to cool and dehumidify the air for use in a compressor of a gas turbine-based generator system that produces electrical power.

10. The system of claim 1, wherein the cold compartment includes a plurality of ice storage containers.

11. The system of claim 1, further comprising piping that carries the ammonia, and wherein the heating mechanism comprises an electrical heating coil coupled to the piping to heat the ammonia carried within the piping exterior to the hot compartment.

12. The system of claim 1, wherein the system is configured to heat ammonia of the ammonia-water absorption cycle to drive the cycle via heat from the hot compartment.

13. The system of claim 12, wherein the system is configured to heat ammonia of the ammonia-water absorption cycle to drive the cycle via heat form the hot compartment by passing the ammonia through a heat exchanger of the ammonia-water absorption cycle that is heated by the first material.

14. The system of claim 13, wherein the at least one ice storage container includes an evaporator of the ammonia-water absorption cycle that receives cooled liquid ammonia of the ammonia-water absorption cycle.

15. The system of claim 14, wherein the evaporator includes tubing containing the cooled liquid ammonia and at least one evaporator plate coupled to the tubing.

16. The system of claim 15, wherein the at least one ice storage container further includes a fluid for the formation of the ice therefrom and an airspace.

17. The system of claim 15, wherein the at least one ice storage container is airtight.

18. The system of claim 1, wherein the system further comprises a control system that controls the hot and cold sections such that the cold section utilizes the ammonia-water absorption cycle to form the ice as a continuous ice making process while previously-formed ice contained within the at least one cold compartment melts.

19. The system of claim 1, wherein the system further comprises a control system that controls the hot and cold sections such that the cold section forms ice at substantially the same rate as previously-formed ice therein melts such that no net ice is formed in the at least one ice storage container.

20. The system of claim 1, wherein the system further comprises a control system that controls the hot and cold sections such that the cold section forms a bulk of ice at a first time period in the at least one ice storage container to cool the second material during a second time period subsequent to the first time period.

21. The system of claim 1, wherein the system is configured to heat the ammonia of the ammonia-water absorption cycle to drive the cycle and form the ice via the first electrical power source during a first time period and via the hot compartment a second time period that differs from the first time period.

22. The system of claim 21, wherein the system is configured to heat the ammonia of the ammonia-water absorption cycle via the hot compartment at the second time period by passing the ammonia through a heat exchanger that is heated by the first material.

23. The system of claim 1, further comprising a housing, and wherein at least the hot compartment and the at least one cold compartment are contained within the housing.

24. A system for treating air for an electrical power generation system, comprising:
a cold section including a thermally insulated cold compartment with at least one ice storage container, the cold section being configured to selectively form ice within the at least one ice storage container via an ammonia-water absorption cycle and to cool and dehumidify air via the cold compartment for feeding to a compressor of a turbine-based generator system for the generation of electrical power; and
a hot section including a thermally insulated hot compartment including thermal energy storage material, the hot section being configured to heat the thermal energy storage material via at least a first electrical power source and to selectively heat ammonia of the ammonia-water absorption cycle to drive the cycle and form the ice via the first electrical power source and the hot compartment, and
wherein the hot compartment and the at least one cold compartment are differing compartments that are thermally insulated from each other.

25. An energy storage and generation system, comprising:
a hot section including a thermally insulated hot compartment including thermal energy storage material, the hot section being configured to heat the thermal energy storage material via at least a first electrical power source and to pass input water and air through the hot compartment to produce steam and heated air therefrom;
a turbine configured to drive a generator to produce electricity, the turbine configured to receive the steam produced by the hot section and to exhaust the steam after use thereby; and
a cold section including a thermally insulated cold compartment with at least one ice storage container, the cold section being configured to form ice within the at least one ice storage container via an ammonia-water absorption cycle and to condense the steam exhausted by the turbine to form the input water,
wherein the system is configured to heat ammonia of the ammonia-water absorption cycle to drive the cycle and form the ice via at least the heated air produced by the hot section and the first electrical power source, and
wherein the hot compartment and the at least one cold compartment are differing compartments that are thermally insulated from each other.

26. A thermal energy storage system, comprising:
an ammonia-based cooling system comprising an ammonia-water absorption cycle including an evaporator portion coupled to an evaporator plate; and
a coolant-based cooling system comprising a closed loop of coolant selectively flowing through a chiller, a cold compartment, an ice storage tank including a first material, and a heat exchanger configured to selectively cool a flow of second material flowing therethrough,
wherein the evaporator portion and evaporator plate of the ammonia-based cooling system are positioned within the cold compartment to selectively cool the flow of coolant, and
wherein the coolant-based cooling system includes an ice storage mode, wherein the chiller cools the flow of coolant to a temperature below a freezing temperature of the first material and the cooled flow of coolant passes through the ice storage tank to freeze a first batch of the first material, and an ice melt mode, wherein the chiller is deactivated and the flow of coolant is cooled by the first batch of ice within the ice storage tank and the coolant-based cooling system via the cold compartment.
